(19) United States
(12) Patent Application Publication
(10) Pub. No.: US 2002/0191779 A1
(43) Pub. Date: Dec. 19, 2002

(54) System for convolutional echo cancellation by iterative autocorrelation

(76) Inventor: Tien Pham, San Jose, CA (US)

Correspondence Address: GLENN PATENT GROUP, 3475 EDISON WAY, SUITE L, MENLO PARK, CA, 94025, US

(21) Appl. No.: 09/816,987

(22) Filed: Mar. 23, 2001

(51) Int. Cl. H04M 9/08

(52) U.S. Cl. 379/406.08; 379/406.01

(57) ABSTRACT

System are provided for blind echo cancellation in wireless signal processors, such as for wireless repeaters. A first embodiment of the echo cancellation system provides iterative echo cancellation for white signals, with channel identification. A second embodiment of the echo cancellation system provides iterative echo cancellation for band-limited signals, without channel identification, through the determination of a the second order statistics of a signal. The echo cancellation systems are fast, and can be implemented using modern DSP processors for CDMA and broadband wireless communication systems. Analyses and simulations show that the echo cancellation systems can achieve echo cancellation of 40 dB or more at a modest computational cost of several hundred MMACs.

### FIELD OF THE INVENTION

The invention relates to the field of signal processing systems. More particularly, the invention relates to an echo canceling system which provides improved signal quality for wireless signals, such as for CDMA signals.

### BACKGROUND OF THE INVENTION

In wireless communication systems, repeaters are often used to extend coverage and to reduce cost. A main concern in the use of repeaters is the occurrence of echoes, which are often a result of leakage from a transmitting antenna to a receiving antenna, and/or the result of reflection off nearby objects.

One conventional technique to reduce the occurrence of echoes for CDMA systems has been to increase the separation distance between reception antennas. An alternate technique to reduce the occurrence of echoes has been to place the mounting tower for reception antennas at an isolated location. Both of these approaches typically add significant costs and restrictions to system deployment. It would be advantageous to provide a system which can track and cancel the echoes adaptively for a wireless receiver, such that the cost of system deployment is minimized.

Conventional methods for echo cancellation are channel identification and equalization, which can be blind or non-blind, as described in S. Benedetto, Principles of Digital Transmission with Wireless Applications, New York: Kluwer Academic, 1999. Non-blind methods make use of a training signal to identify the channel and equalize it to suppress the echoes. These methods, despite the drawback of reducing bandwidth, have been successfully implemented in TDMA systems such as GSM and IS-54. In theory, training signals can also be used in a CDMA system for channel identification, but they are often impractical for CDMA systems, because of the requirement for low transmitted power, which requires excessive computation to obtain an accurate channel impulse response (IR). Conventional blind methods do not use system bandwidth, but rely on either cyclostationadity of the signals or higher-order statistics of non-Gaussian signals to extract channel information. However, in CDMA systems, since signals behave like Gaussian noise, channel equalization is often ignored, as evident from very limited amount of research publications in this area.

Prior deconvolution techniques are disclosed in W. K. Yeung and F. N. Kong, Time Domain Deconvolution when Kernel has No Spectral Inverse, IEEE Trans. Acoust., Speech, Signal Processing, vol. ASSP-34, pp. 912-918, August 1986; and in T. E. Tuncer, A New method for D-Dimensional Exact Deconvolution, IEEE Trans. Signal Processing, vol. 47, pp. 1324-1334, May 1999. While such deconvolution techniques attempt to improve noise tolerance, they typically require excessive computation.

The disclosed prior art systems and methodologies thus provide basic echo reduction or cancellation systems, such as by customized system deployment, i.e. antenna separation, antenna location, or by echo cancellation of TDMA signals, by channel identification and equalization using a training signal. However, these methods are impractical for CDMA systems, because they require low transmitted power, resulting in excessive computation to obtain an accurate channel impulse response (IR). It would therefore be advantageous to provide an echo cancellation structure and process, whereby band-limited or white noise signals are adaptively canceled, without the aid of a training signal. The development of such a echo cancellation system for white signals would constitute a major technological advance. The development of such a echo cancellation system for band-limited signals would constitute a further technological advance.

### SUMMARY OF THE INVENTION

Systems are provided for blind echo cancellation in wireless signal processors, such as for wireless repeaters. A first embodiment of the echo cancellation system provides iterative echo cancellation for white signals, with channel identification. A second embodiment of the echo cancellation system provides iterative echo cancellation for band-limited signals, without channel identification, through the determination of the second order statistics of a signal. The disclosed echo cancellation systems are fast, and can be implemented using modern DSP processors for CDMA and broadband wireless communication systems. Analyses and simulations show that the echo cancellation systems can achieve echo cancellation of 40 dB or more at a modest computational cost of several hundred MMACs.

### BRIEF DESCRIPTION OF THE DRAWINGS

FIG. 1 shows a baseband model of a repeater in the presence of echoes;

FIG. 2 shows a baseband model of a primary echo which arrives at the input port of the signal processor, and is processed with the input signal;

FIG. 3 is a baseband model which shows a secondary echo which arrives at the input port of the signal processor, and is processed with the input signal and the primary echo;

FIG. 4 is a graph which shows the impulse response of the overall channel with an alipass DCSF in the presence of echoes;

FIG. 5 is a graph which shows the autocorrelation function (ACF) of the total output signal for a white, gaussian input signal;

FIG. 6 is a graph showing the magnitude and location of a desired signal and associated echoes;

FIG. 7 is a graph showing the impulse response of a bandpass DCSF;

FIG. 8 is a graph showing the impulse response of the overall channel in the presence of echoes;

FIG. 9 is a graph showing the autocorrelation function (ACF) of the output signal;

FIG. 10 is a block diagram of an white-echo canceling system for a repeater circuit;

FIG. 11 is a block diagram of a band-limited-echo canceling system for a repeater circuit;

FIG. 12 is a graph showing normalized output power as a function of delay estimation error after a first iteration of an echo cancellation loop;

FIG. 13 is a block diagram of an iterative echo cancellation process for band-limited signals;

FIG. 14 is a graph showing a plurality of neighboring CDMA bands;

FIG. 15 is a graph showing the ACF for an echo-free input signal with uniform power spectrum across a selected band;

FIG. 16 is a graph showing the power spectrum for the echo-free input signal of FIG. 15, with uniform power spectrum across a selected band;

FIG. 17 is a graph showing the ACF for the input signal of FIG. 15 in the presence of two echoes, with uniform power spectrum across a selected band;

FIG. 18 is a graph showing the power spectrum for the input signal of FIG. 15, in the presence of two echoes, with uniform power spectrum across a selected band;

FIG. 19 is a graph showing the ACF for the input signal of FIG. 15, in the presence of two echoes, with uniform power spectrum across a selected band, after a first iteration of echo-cancellation;

FIG. 20 is a graph showing the power spectrum for the input signal of FIG. 15, in the presence of two echoes, with uniform power spectrum across a selected band, after a first iteration of echo-cancellation;

FIG. 21 is a graph showing the ACF for the input signal of FIG. 15, in the presence of two echoes, with uniform power spectrum across a selected band, after a fourth iteration of echo-cancellation;

FIG. 22 is a graph showing the power spectrum for the input signal of FIG. 15, in the presence of two echoes, with uniform power spectrum across a selected band, after a fourth iteration of echo-cancellation;

FIG. 23 is a graph showing a resultant FIR filter impulse response and echo channel impulse response, after a fourth iteration of the echo cancellation process;

FIG. 24 is a graph showing the output signal ACF, for the input signal of FIG. 15 in the presence of three echoes, with the eighth CDMA band selected;

FIG. 25 is a graph showing the output signal power spectrum, for the input signal of FIG. 15 in the presence of three echoes, with the eighth CDMA band selected;

FIG. 26 is a graph showing the output signal ACF, for the input signal of FIG. 15 in the presence of three echoes, with the eighth CDMA band selected, after a fourth iteration of the echo cancellation process; and

FIG. 27 is a graph showing the output signal power spectrum, for the input signal of FIG. 15 in the presence of three echoes, with the eighth CDMA band selected, after a fourth iteration of the echo cancellation process.

### DETAILED DESCRIPTION OF PREFERRED EMBODIMENTS

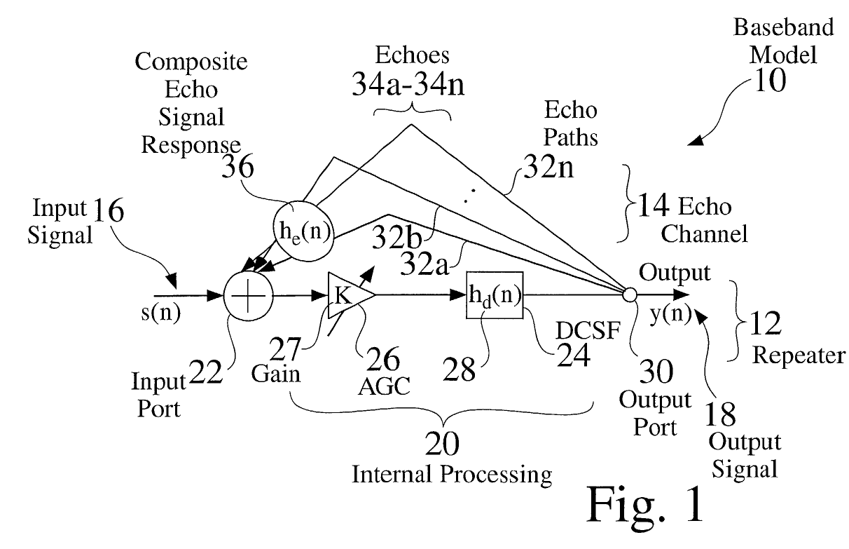

FIG. 1 shows a block diagram of simplified baseband model 10 of a repeater 12, with an input signal s(n) 16, in the presence of one or more echoes 34a-34n within an echo channel 14. In FIG. 1, h_{d}(n) is the impulse response 28 of the digital channel selecting filter (DCSF) 24, having 0 db gain in the passband, and hₑ(n) is the echo channel impulse response 36 representing one or more echoes 34a-34n, typically comprising antenna leakage and/or reflections. In FIG. 1, the variable gain 27 is shown as K, and the input signal 16 and echoes 34a-34n have arbitrary powers, while the thermal noise is assumed to be negligible.

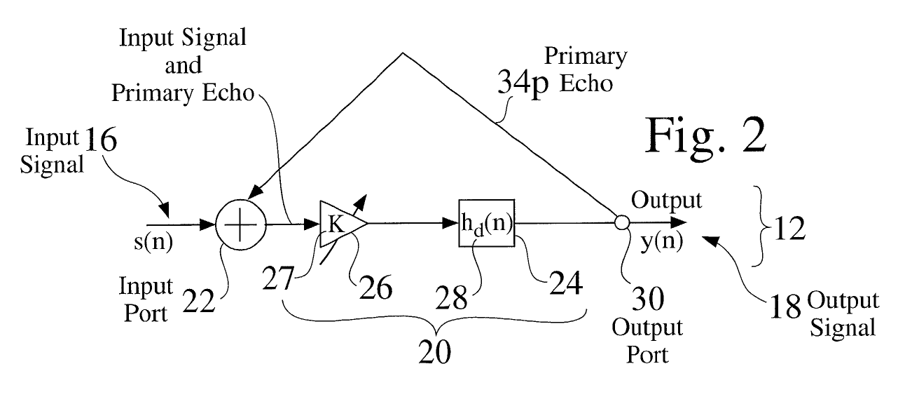

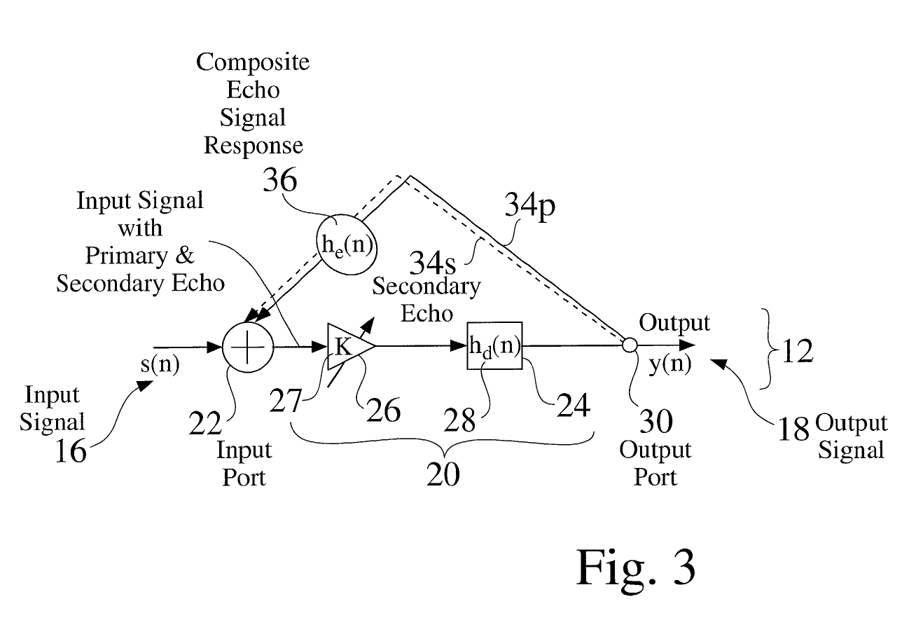

FIG. 2 shows a primary echo 34p which arrives at the input port 22 of the signal processor 12, and is processed with the input signal 16. FIG. 3 shows a primary echo 34p, as well as a secondary echo signal 34s, in which the secondary echo 34s is an echo 34 based upon the processed primary echo signal 34p shown in FIG. 2. In

FIG. 3, the secondary echo 34s, along with the primary echo 34p, arrive at the input port 22 of the signal processor 12, and is processed with the input signal 16 and the primary echo 34p.

The relationship between the output signal y(n) 18 and the input signal s(n) 16 in the time domain is shown as:

y(n)=Ks(n)*h_{d}(n)+K_{y}(n)*hₑ(n)*h_{d}(n). (1)

where the symbol “*” denotes a convolution operation. If the attenuation is large enough such that secondary echoes 34s are insignificant compared to the primary echoes 34p, the relationship between the output signal y(n) 18 and the input signal s(n) 16 may be approximated as shown:

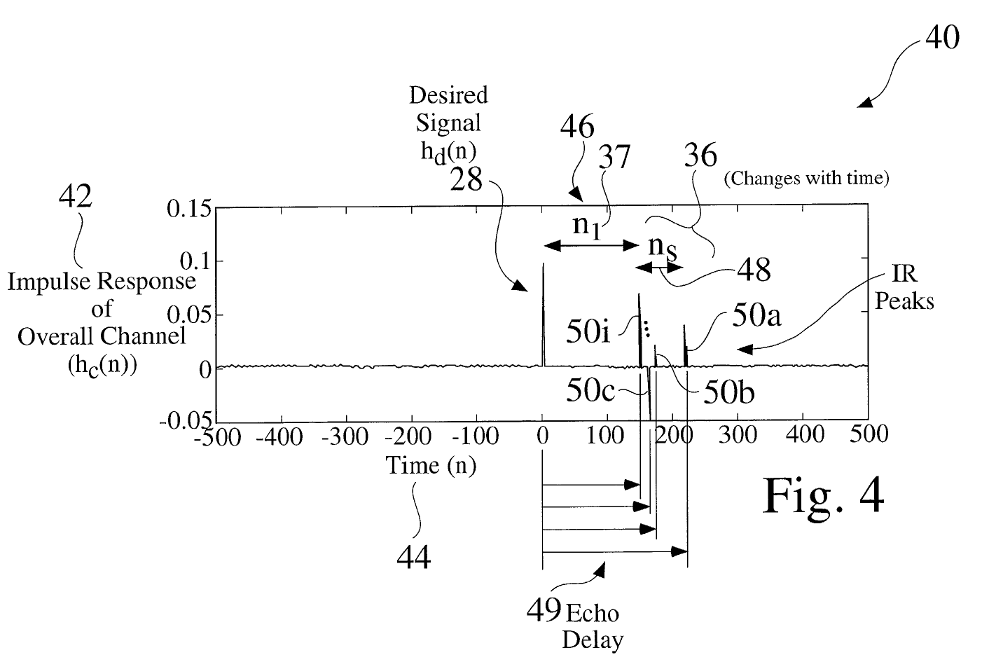

y(n)=Ks(n)* h_{d}(n)*{δ(n)+Khₑ(n)* h_{d}(n)}=s(n)* h(n) (2)

where δ(n) denotes the discrete-time delta function, where the impulse response 42 (FIG. 4) of the overall channel is shown as

h_{c}(n)=Kh_{d}(n)* h_{b}(n), (3)

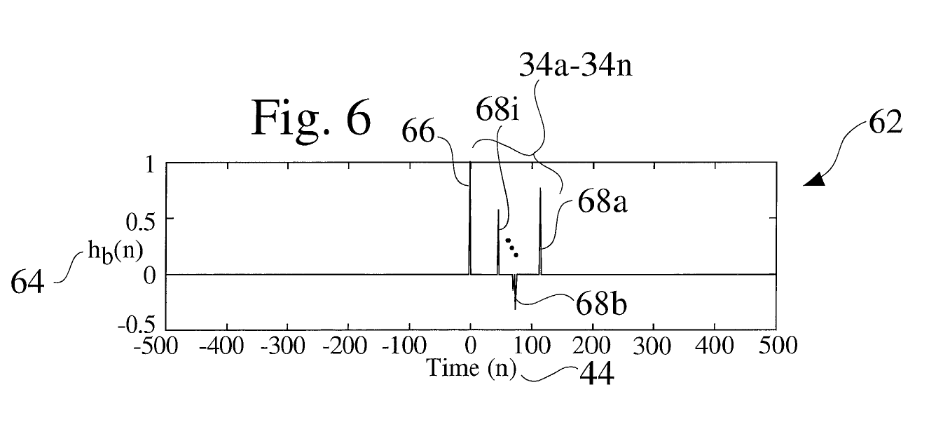

and where the composite channel impulse response h_{b}(n) 64 (FIG. 6) is shown as

h_{b}(n)=δ(n)+Khₑ(n)* h_{d}(n), (4)

which represents both the desired output signal 18 and the echoes 34a-34n.

In the following analysis, the second-order statistics of the input signal 16, as well as the DCSF impulse response h_{d}(n) 28, are assumed to be known, whereas the echo channel impulse response hₑ(n) 36, from one or more echoes 34a-34n, is unknown, and may change with time.

Properties of an Autocorrelation Function of a Signal with Echoes. The autocorrelation function (ACF) 54y of the output signal 18 is used to derive information regarding the channel, and to cancel the echoes 34a-34n. The autocorrelation function ACF 54y of an ergodic process y(n) is defined as

R_{y}(n)=y(n)* y(−n). (5)

A random process is said to be ergodic in the most general form of all of its statistical properties can be determined from a sample function representing one possible realization of the process, as described in S. Haykin, An Introduction to Analog and Digital Communications; New York: John Wiley & Sons, 1989.

Similarly, Rₛ(n) is the autocorrelation function 54s for the input signal s(n) 16, R_{c}(n) is the autocorrelation function 54c for the overall channel impulse response h_{c}(n) 42 (FIG. 4), R_{d}(n) is the autocorrelation function 54d for the DCSF impulse response h_{d}(n) 28 of the digital channel selecting filter 24, and R_{b}(n) is the autocorrelation function 54b for the composite channel impulse response h_{b}(n) 64, respectively. While the overall channel impulse response h_{c}(n) 42, the DCSF impulse response h_{d}(n) 28, and the composite channel impulse response h_{b}(n) 64 are deterministic impulse responses, the corresponding ACF definitions, being similar to Equation (5), are appropriate.

Through the substitution of Equation (2) into Equation (5), and the use of the communicative and associative properties for a convolution operation, the output signal R_{y}(n) can be expressed as

R_{y}(n)=Rₛ(n)* R_{c}(n), (6)

i.e. the output signal ACF R_{y}(n) 54y is the convolution of the input signal Rₛ(n) ACF 54s and the channel ACF R_{c}(n) 54c. Similarly,

R_{c}(n)=R_{d}(n)* R_{b}(n), (7)

so the output signal autocorrelation function ACF 54y is given as

R_{y}(n)=Rₛ(n) R_{d}(n)* R_{b}(n). (8)

The characteristics of output signal ACF R_{y}(n) 54y are described below, for white signals 16a and for band-limited signals 16b. A white signal 16a is defined as a signal having a uniform spectral density over the Nyquist bandwidth, which is half of the sampling frequency. A band-limited signal 16b is defined as a signal having any spectrum density up to the Nyquist frequency.

Characteristics of the ACF of a White Desired Signal and Echoes at the Output. For a white input signal 16a within a signal processor 12, e.g. such as for the repeater 12a shown in FIG. 1, in which the digital channel select filter DCSF 24 is an allpass filter, both the desired output signal y(n) 18, as well as one or more echoes 34a-34n at the output port 30, are white signals 16a. However, the combined total output signal 18 is non-white, due to frequency selective fading caused by the echoes 34a-34n.

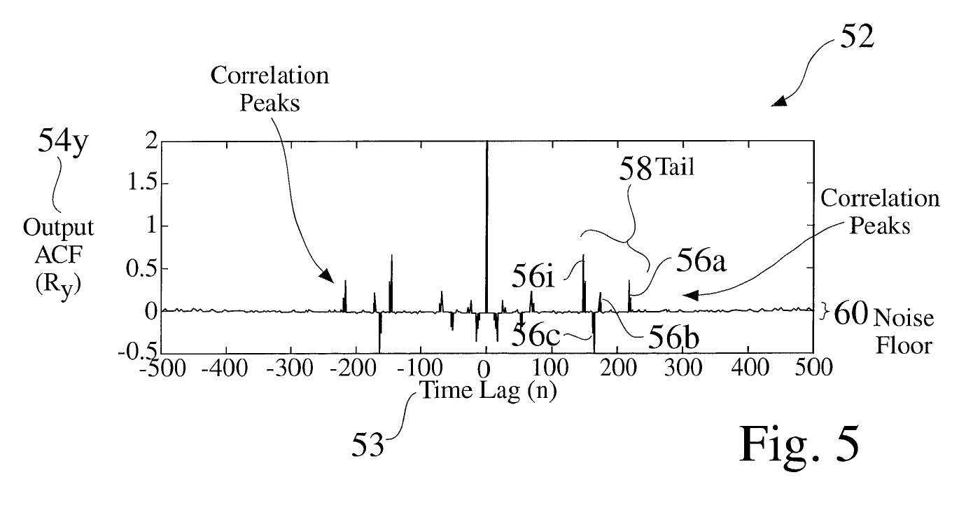

FIG. 4 is a graph 40 which shows the impulse response 42 of the overall channel with an allpass DCSF 24 in the presence of echoes 34a-34n, as a function of time 44. FIG. 5 shows the output signal ACF 54y of the total output signal 18, for a white, Gaussian input signal 16a. For an input signal s(n) 16 which is a Gaussian signal, having an rms amplitude “a”, the autocorrelation function Rₛ(n) 54s of the white Gaussian input signal 16a is given as

Rₛ(n)=a²δ(n) (9)

Since an allpass digital channel select filter DCSF 24 has 0 db gain, the DCSF impulse response 28, represented by h_{d}(n), is equal to δ(n). The impulse response h_{c}(n) 42 of the overall channel, as seen in Equations (3) and (4), can alternately be written as

h_{c}(n)=K{δ(n)+Khₑ(n)}, (10)

where the first term of the sum represents the DCSF impulse response 28, and the second term represents the impulse response 36 due to one or more echoes 34a-34n, which are typically comprised of one or more few impulse response (IR) peaks 50a-50i, as shown in FIG. 4.

The output signal ACF R_{y}(n) 54y, having distinct correlation peaks 56a-56i, is shown in FIG. 5. The output signal ACF R_{y}(n) 54y of the total output signal 18, for a system which uses a finite number of samples for the ACF estimation, may have a discernable noise floor 60. As seen in FIG. 5, the tail 58 of the output signal ACF 54y has a similar shape to the echo channel impulse response 36 due to one or more echoes 34a-34n, corresponding to IR peaks 50a-50i, as shown in FIG. 4.

From Equation (7) to Equation (10), the output signal ACF R_{y}(n) 54y is shown as

R_{y}(n)=a²K²{δ(n)+Khₑ(n)}*{δ(−n)+Khₑ(−n)}; (11)

R_{y}(n)=a²K²{δ(n)+Khₑ(n)+Khₑ(−n)+K²hₑ(n)* hₑ(−n)}. (12)

If the echo delay spread is nₛ 48, as shown in FIG. 4, ire. the echo channel impulse response hₑ(n) is non-zero only for n_{d}≦n≦n_{d}+nₛ, then the autocorrelation function hₑ(n)×hₑ(−n), is non-zero only for −nₛ≦n≦nₛ. For any channel with finite echo delay spread nₛ 48, the output signal ACF R_{y}(n) 54y may be expressed as

R_{y}(n)=a²K³hₑ(n), where n>nₛ. (13)

If n₁>nₛ, R_{y}(n)=a²K³hₑ(n), where n>n₁. Therefore, if the delay of the first echo 34a is larger than the echo delay spread 48, the echo channel impulse response 36 is known, from the output signal ACF R_{y}(n) 54y, upon a proportionality constant.

If n₁≦nₛ, only part of the composite echo impulse response hₑ(n) 36 is known from the output signal ACF R_{y}(n) 54y. However, the echoes 34a-34n can be canceled gradually, starting with those echoes which having largest delays 49. e.g. such as echo 34a, corresponding to impulse response peak 50a in FIG. 4. The autocorrelation function 54y can then be estimated again, to reveal information about echoes 34 having smaller delays e.g. such as echoes 34b-34i, corresponding to impulse response peaks 50b-50i, as shown in FIG. 4.

The process of estimating the autocorrelation function 54y, and providing an appropriate cancellation signal to the input 22 of the signal processor 12 is preferably repeated, until all the echoes 34a-34n are canceled (or are substantially reduced to an acceptable level), whereby the entire echo channel impulse response hₑ(n) 36 is determined.

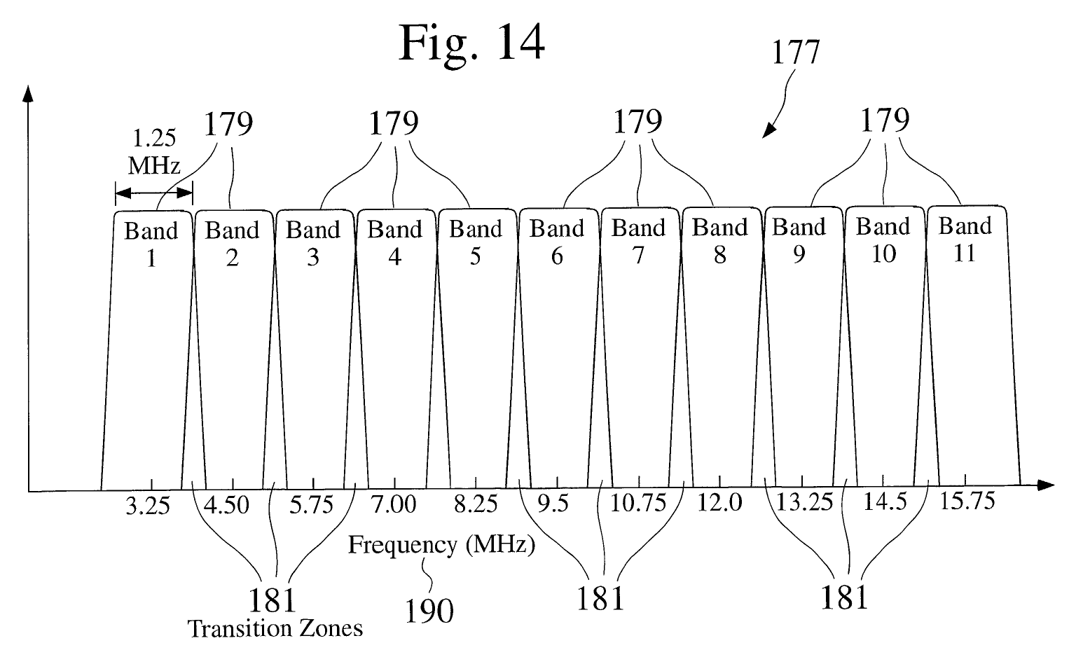

Characteristics of the ACF of Band-Limited Signals and Echoes at the Output. For a signal processor 12 which creates band-limited output signals 18, the digital channel selecting filter DCSF 24 is typically a bandpass filter 24 which may select only a few of a plurality of bands within an arriving input signal 16b, e.g. such as only a few of total 11 CDMA bands 179 (FIG. 14) within an arriving multi-carrier CDMA input signal 16b. In a signal processor 12 which operates on band-limited output signals 18, therefore, the DCSF impulse response h_{d}(n) 42 is not a delta function, such as for a white signal 16a. Instead, the DCSF impulse response h_{d}(n) 42 producing a band-limited signal 18 has a finite duration. For a small number of bands 179 which are selected within the signal processor 12 for a band-limited signal 18, the finite duration of the impulse response h_{d}(n) 42 is relatively long. Conversely, for a larger number of bands 179 selected within the signal processor 12, the finite duration of impulse response h_{d}(n) 42 is relatively smaller.

The desired band-limited output signal 18b is the band-limited input signal 16b, as filtered through the digital channel selecting filter DCSF 24. Echoes 34a-34n occur when the desired signal 16b output is fed back, across echo paths 32a-32n (FIG. 1), and is filtered by the digital channel selecting filter DCSF 24. For a digital channel selecting filter DCSF 24 which has sharp roll-off in transition bands 181 (FIG. 14 between band zones 179), echoes 34a-34n which pass through the digital channel selecting filter DCSF 24 are not changed significantly, except being delayed by n_{d}, which is half the duration of h_{d}(n), with respect to the desired output signal 18b. Therefore, for a band-limited output signal 18b, Equation (4) may be replaced with

h_{b}(n)≡δ(n)+Khₑ(n−n_{d}) (14)

when calculating the output signal ACF 54y, using the convolution operation shown in Equation (8). In this case, while the composite signal ACF R_{b}(n) 54b, given as R_{b}(n)=h_{b}(n)*h_{b}(−n), has distinct peaks 50, the output signal ACF R_{y}(n) 54y does not, because of the dispersive effect of the DCSF ACF R_{d}(n) 54d, given as R_{d}(n)=h_{d}(n)*h_{d}(−n).

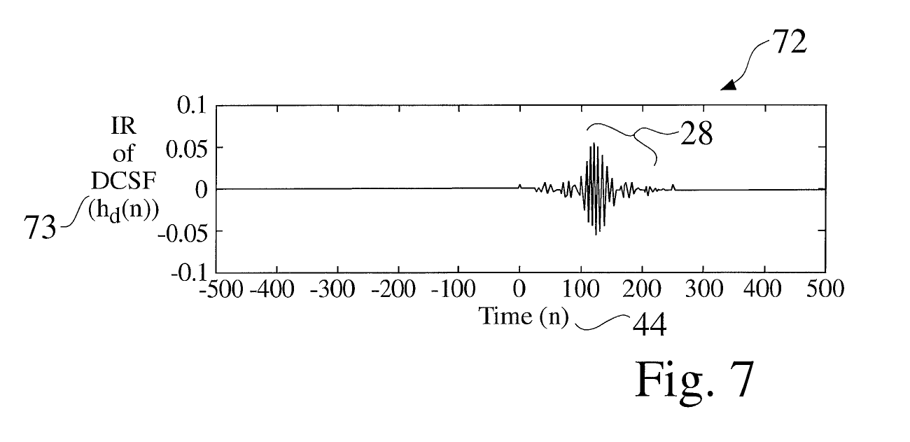

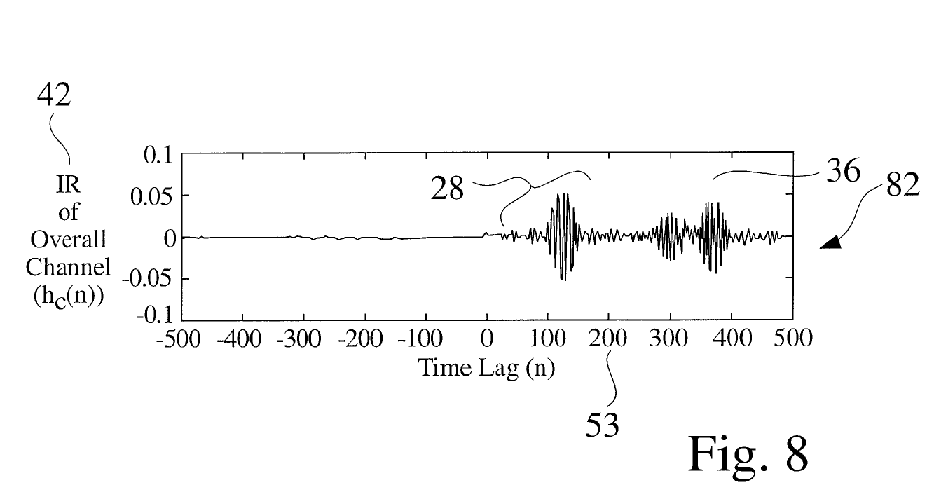

FIG. 6 is a graph 62 which shows the magnitude and location 64 of an input signal composite channel h_{b}(n) 64, which comprises the magnitude and location 66 of the desired channel h_{d}(n) 28, as well as magnitude and location 68a-68i of one or more associated echoes 34a-34i. FIG. 7 is a graph 72 which shows the DCSF impulse response h_{d}(n) 28 of a bandpass DCSF 24, producing a band-limited gaussian output signal 18b. FIG. 8 is a graph 82 which shows the overall channel impulse response h_{c}(n) 42, in the presence of echoes 34a-34i, through a bandpass DCSF 24, producing a band-limited gaussian output signal 18b. The overall channel impulse response h_{c}(n) 42 comprises both the band-limited impulse response h_{d}(n) 28, as shown in FIG. 7, as well as the impulse response 36 of a composite channel impulse response h_{b}(n) 64.

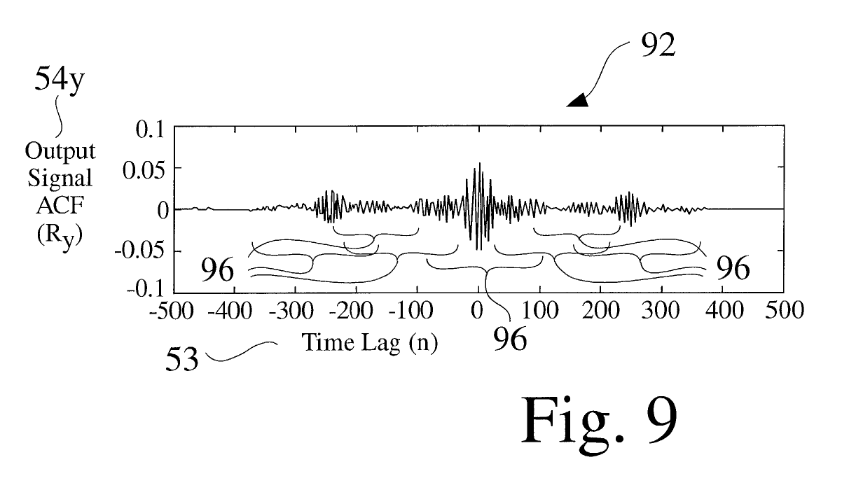

FIG. 9 is a graph 92 which shows the output signal ACF 54y. For an input signal 16 which is white, or has a wider bandwidth than the overall channel impulse response h_{c}(n) 42, the output signal ACF 54y comprises a plurality of correlation peaks 96, which are largely merged together, i.e. the correlation peaks substantially overlap, as seen in FIG. 9.

For correlation peaks 96 which are largely merged together, echo cancellation through iterative channel identification within the echo channel impulse response hₑ(n) 36 is typically impractical. However, as described below, such band-limited signals may still be processed, without channel identification, to significantly reduce or eliminate the echo channel impulse response hₑ(n) 36 from the overall channel impulse response h_{c}(n) 42, whereby the entire composite signal is iteratively processed, to progressively cancel the echoes.

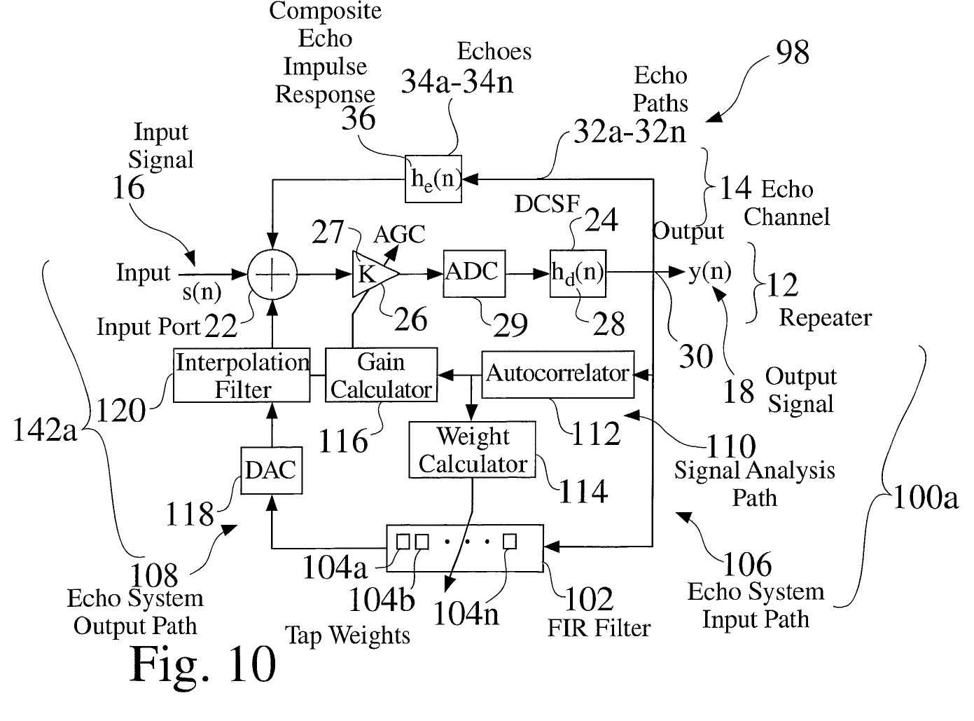

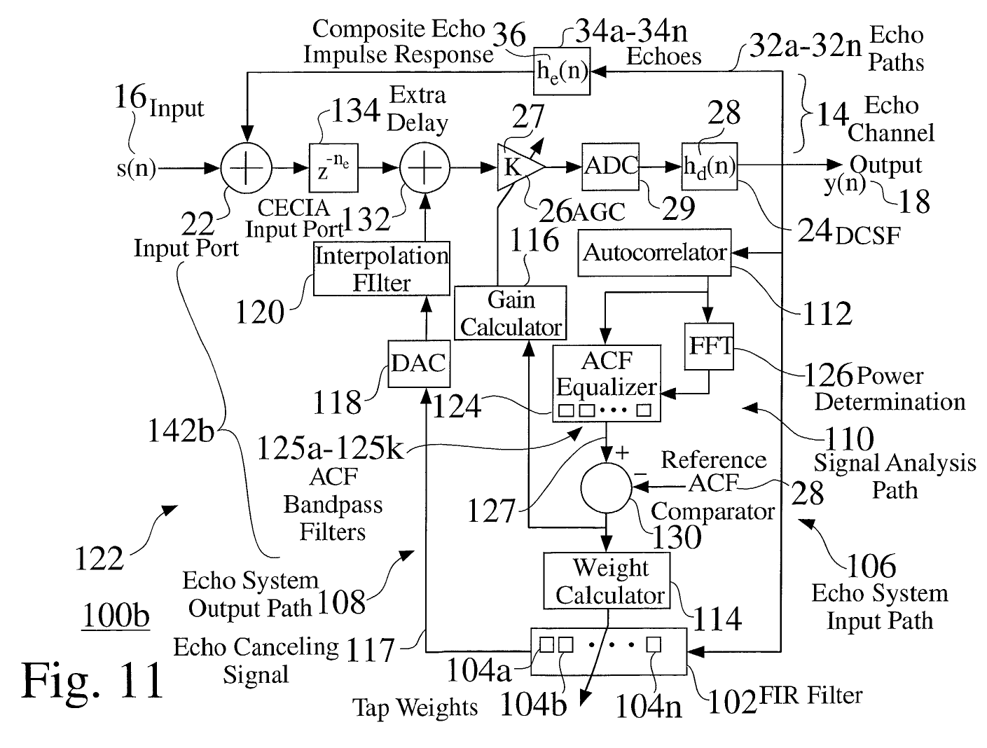

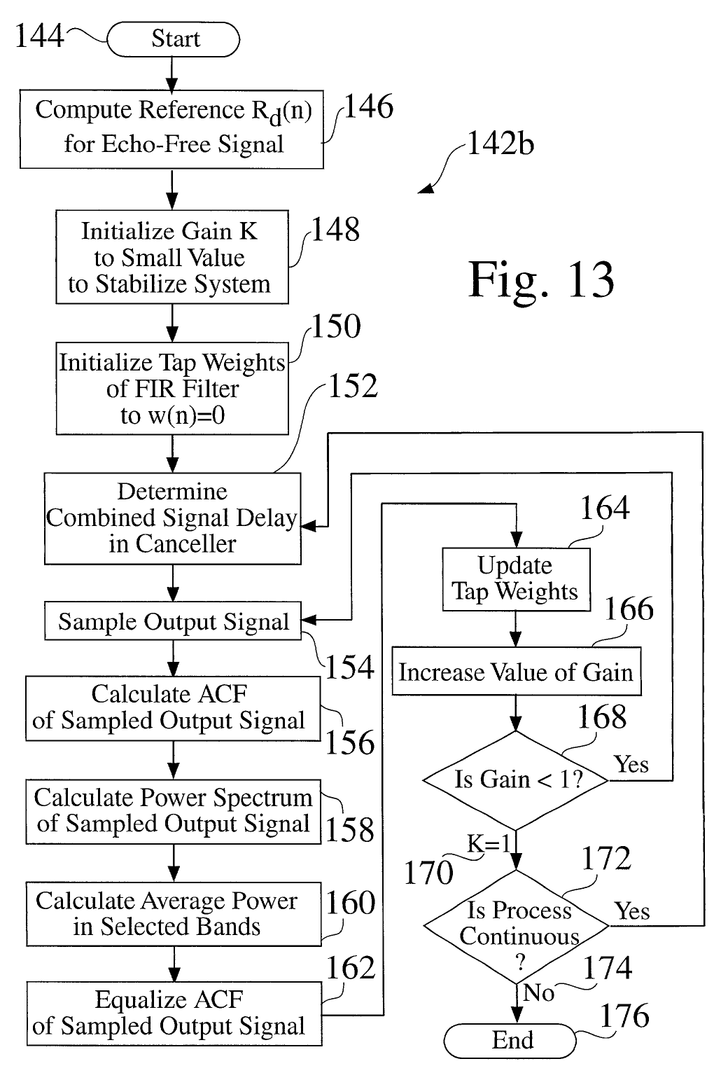

Structures and Algorithms. Echo cancellation structures 100a, 100b and associated cancellation processes 142, such as shown in FIG. 10, FIG. 11, and FIG. 13, are based upon adaptive signal processing, and may be used for echo canceling for a wide variety of signals, such as for white signal echoes 34, as well as for band-limited echoes 34. White echoes 34 are a special case of band-limited echoes 34.

White Echo Cancellation Processes. Signal echoes 34a-34n are created by feedback channels, wherein signals 18 which are output by a signal processor 12 are fed back through the input 22 of the signal processor 12. Similarly, the iterative echo canceling system 100a provides signal processing from the output 30 of a signal processor 12 to the input 22.

FIG. 10 is a block diagram 98 of a white-echo canceling system 100a for a repeater circuit 12. The white-echo canceling system 100a shown in FIG. 10 comprises a FIR filter 102, comprising tap weights 104a-104n. The tap weights 104a-104n are driven by an adaptive echo cancellation algorithm 142a, which is based upon the second order statistics, i.e. typically the power spectrum, or equivalently the ACF of the output signal y(n) 18, such as the output signal ACF R_{y}(n) 54y. The FIR filter 102 is connected to the output of the repeater 12 by an echo system input path 106, and is connected to the input of the repeater 12 by an echo system output path 108. A signal analysis path 110 is located between the echo system input path 106 and the echo system output path 108. An autocorrelator 112 provides signal analysis of a received output signal 18. A weight calculator 114 is connected to the autocorrelator 112, and controls the tap weight for the FIR filter 102. A gain calculator 114 is also connected to the autocorrelator 112, and controls the gain 27 for the automatic gain controller 26. A DAC 108 and an interpolation filter 120 are located on the echo system output path 108, and the gain calculator 116 is connected to the echo system output path 108, through the interpolation filter 120.

The white echo canceling system 100a shown in FIG. 10 comprises an automatic gain controller (AGC) 26, which performs many functions, such as stabilizing the system 12, 100a, to prevent large echoes 34 from causing oscillations, and controlling the gain 27 of the system 100a, thus making secondary echoes negligible, i.e. such that only primary echoes 34 are significant, as seen in Equation (2).

At the beginning of the white echo cancellation process 142a, the gain 27 is preferably set to a small value, whereby only the largest primary echoes 34 are significant. After the largest echoes 34 are canceled, the gain 27 is controllably increased, whereby smaller primary echoes 34 are preferably processed and successively canceled. Once the gain 27 has reached its maximum value for normal operation, the echo canceller 100a is typically fast enough to eliminate any newly arising echoes 34, thereby preventing subsequent echoes 34 from growing and potentially destabilizing the signal processing system 12, 100a.

For an echo canceling system 100a in which the A/D converter, D/A converter 118, and interpolation filter (IPF) 120 do not introduce significant delay or frequency distortion to the signal paths, the overall channel impulse response h_{c}(n) 42, as given by Equation (10), becomes

h_{c}(n)=K{δ(n)+K(hₑ(n)+w(n))}, (15)

where the tap weights 104 of the FIR filter 102 are represented by w(n). For perfect echo cancellation, therefore, the tap weight 104 of the FIR filter 102 is equal in magnitude to the echo channel impulse response hₑ(n) 36, and is negative in value to the echo channel impulse response hₑ(n) 36, as shown:

w(n)=−hₑ(n). (16)

Therefore, the number of tap weights 104a-104n are preferably at least the length nₛ 48 of the echo channel impulse response hₑ(n) 36. As seen in FIG. 4 and FIG. 5, as discussed above, the output signal autocorrelation function R_{y}(n) 54y comprises distinct correlation peaks 56a-56i, and the echo channel impulse response hₑ(n) 36 is partly or fully known from the tail 58 of the output signal autocorrelation function R_{y}(n) 54y, upon the proportionality constant a²K³. While the gain K 27 is controlled through the autocorrelator 112 and is known, the proportionality constant “a” is initially unknown. However, “a” is readily determined, by using a trial echo cancellation 142a. As well, the location and magnitude of the echo 34 with the largest delay is always known for the white output signal 18.

After the echo 34 with the largest delay 49 is canceled, the output signal autocorrelation function R_{y}(n) 54y is re-estimated, and the echo 34 with the next largest delay 49 is then determined, and can then be canceled by the system 100a. Subsequent iteration of the echo cancellation process 142a therefore provides subsequent cancellation for each of the echoes 34a-34n. The white signal echo cancellation system 100a and process 142a therefore provides echo cancellation by iterative autocorrelation, whereby the echo channel impulse response 36, comprising one or more echoes 34a, 34b . . . 34n is gradually canceled.

A contributing factor which may decrease the accuracy of white noise cancellation is thermal noise. As well, for a system in which a relatively small finite number of samples are used for the estimation of the output signal autocorrelation function R_{y}(n) 54y, the echo channel impulse response 36 may not be accurately determined within the ACF tail 58 (FIG. 5), due to correlation noise, whereby the result of echo cancellation signal processing may not be perfect.

For white echoes 34a-34n, however, the correlation peaks 56a-56i are typically sharp and distinct from each other, as seen in FIG. 5, and are much higher than the noise floor 60, such as when more than one thousand samples are used. Therefore, the resultant iterative echo cancellation signal is sufficient to provide an accurate representation of the desired impulse response h_{d}(n) 28.

Echo Cancellation System for Band-Limited Signals. For the general case of a typical band-limited output signal 18, the output signal ACF R_{y}(n) 54y does not have distinct sharp correlation peaks 56a-56i, such as seen in FIG. 5 for a white output signal 18a. Therefore, for a typical band-limited signal, the locations and magnitudes of the echoes 34a-34n are unknown unless they are separated by large delays. In practice, the echoes 34a-34n are often closely located, and have a narrow bandwidth, in which correlation peaks 56 disperse and substantially merge together, i.e. the individual contributions from echoes 34a-34n within a composite signal are indistinguishable from each other.

As can be seen by Equation (8), R_{y}(n) is the convolution of Rₛ(n), R_{d}(n), and R_{b}(n). Since R_{y}(n) and R_{d}(n) are known, R_{b}(n) can be found by deconvolution, if Rₛ(n) is known. In this case, the autocorrelation technique discussed above can be used to cancel the echoes 34a-34n. However, the input signal ACF Rₛ(n) 54s is usually unknown for a CDMA input signal 16b, due to changing power levels in the CDMA bands.

As well, deconvolution is a difficult and ill-conditioned problem, when the convolution kernel has spectral nulls, as described by W. K. Yeung and F. N. Kong, Time Domain Deconvolution When Kemel Has No Spectral Inverse, IEEE Trans. Acoust., Speech, Signal Processing, vol. ASSP-34, pp 912-918, August 1986, with deconvolved results being extremely noise sensitive.

Furthermore, for a band-limited signal, such as a band-limited CDMA output signal 18b from a repeater 12, the convolution kernel R_{d}(n) of the desired processed signal is also band-limited, i.e. having many spectral nulls, and the determined output signal ACF R_{y}(n) 54y is noisy, due to a finite number of samples and thermal noise.

When the desired signal ACF R_{d}(n) 54d is band-limited, a portion of the information regarding the echo channel 14, which is contained in the output signal ACF R_{y}(n) 54y, is lost during the convolution step, since a convolution in the time domain is equivalent to multiplication in frequency domain. As a result, deconvolution may produce ambiguous results.

Attempts to deconvolve a composite band-limited signal R_{b}(n) 64, by such techniques as spike filtering and least-square matching (see S. J. Orfanidis, Optimal Signal Processing, McGraw-Hill, 1988), show that even a very small amount of noise which is added to the output signal ACF R_{y}(n) 54 significantly changes the result of the deconvolving process.

The echo canceling system 100b, as shown in FIG. 11, provides echo cancellation without channel identification. While echoes 34a-34n of a band-limited signal are also band-limited, it is not necessary to determine the full spectrum density of the echo channel 14, in order to significantly reduce and/or cancel the echoes 34.

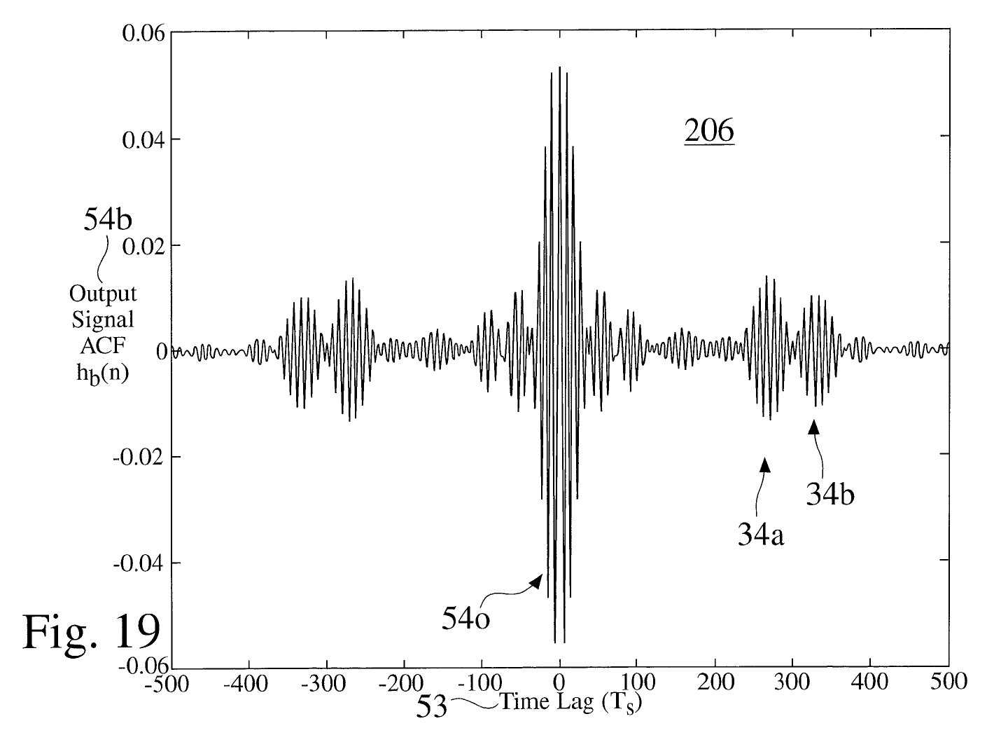

Similar to the derivation of R_{y}(n) given by Equation (12) and Equation (14), the tail of the composite signal ACF R_{b}(n) 54b (FIG. 19, FIG. 41) may be expressed as

R_{b}(n)=Khₑ(n−n_{d}), n>nₛ. (17)

Therefore, the tail of the composite signal ACF R_{b}(n) 54b contains part or full information regarding the echo signal impulse response 36, which is represented by hₑ(n−n_{d}), since the echo signal impulse response 36 of the echoes 34a-34n depends upon the delay n₁ 37, as well as the delay spread nₛ 48.

For a delay which is larger than the delay spread nₛ 48, the impulse response hₑ(n−n_{d}) is fully known from the tail 58 of the composite ACF R_{b}(n) 54b. Therefore, from Equation (8), Equation (9), and Equation (17), the tail of the output signal ACF R_{y}(n) 54y can be expressed as

R_{y}(n)=K³Rₛ(n)*R_{d}(n)*hₑ(n−n_{d}). (18)

The desired signal at the signal processor output port 30 is

y₀(n)=aKh_{d}(n)*s(n) (19)

and the echoes 34a-34n at the input port 30 are shown as

xₑ(n)=aKh_{d}(n)*hₑ(n)*s(n). (20)

From Equation (18) and Equation (19), the convolution between the ACF tail 58 and desired output signal 18 is

C(n)=aK⁴Rₛ(n)*R_{d}(n)*h_{d}(n)*hₑ(n−n_{d})*s(n). (21)

If the digital channel selecting filter DCSF 24 is an ideal filter, with unit magnitude in the passband, R_{d}(n)−h_{d}(n)=h_{d}(n), whereby Equation (21) becomes

C(n)=aK⁴Rₛ(n)*h_{d}(n)*hₑ(n−n_{d})*s(n). (22)

Furthermore, for the limiting case wherein the band-limited input signal is white, i.e. Rₛ(n)=a² δ(n), Equation (22) can be simplified to

C(n)=a³K⁴h_{d}(n)*hₑ(n−n_{d})*s(n). (23)

The echoes represented by Equation (20) and Equation (23) are equivalent, except for the proportionality constant a²K³, and the delay n_{d} of the echo channel 14, which is inherently caused by the digital channel selecting filter DCSF 24.

Therefore, an effective echo cancellation signal can be generated by a convolutional echo cancellation process 142b, which comprises the steps of:

i) determining the negative value of the ACF tail 58 of the composite signal;

ii) adjusting the value by the time delay through the DCSF 24;

iii) scaling the result of the time adjusted value by 1/(a²K³); and

iv) convolving the scaled result with the output signal y(n) 18.

For a band-limited signal whose ACF has no distinct correlation peaks 56a-56i, use of the white cancellation system 100a and associated process 142a may be difficult. The attempted cancellation of one echo 34 may easily introduce new echoes, whereby the I 5 associated iterative echo cancellation algorithm may not converge. Therefore, for the case of a band-limited signal in which only a portion of the echo channel 14 is known from the ACF tail 58 of the composite signal, an alternate embodiment 100b of the echo cancellation system, which provides convolutional echo cancellation 142 by iterative autocorrelation (CECIA), as shown in FIG. 13, is used to gradually cancel one or more echoes 34a-34n.

FIG. 11 is a functional block diagram 122 of a band-limited echo canceling system 100b for a signal processor 12. The band-limited echo canceling system 100b comprises a FIR filter 102, comprising one or more tap weights 104a-104n. The FIR filter 102 is connected to the output of the repeater 12 by an echo cancellation system input path 106, and is connected to the input of the repeater 12 by an echo cancellation system output path 108. A signal analysis path 110 is located between the echo cancellation system input path 106 and the echo cancellation system output path 108. An autocorrelator 112 provides signal analysis of an output signal 18. The output of the autocorrelator 112 is connected to an ACF equalizer 124. The output of the autocorrelator 112 is also connected to a fast Fourier transform FFT module 126, which is also connected to the ACF equalizer 124. The output of the ACF equalizer 124, as well as a reference ACF 128, as described below, are connected to a comparator 130, which calculates their difference. The output of the comparator 130 is directed to a weight calculator 114, which controls the tap weights 104a-104n for the FIR filter 102. A gain calculator 116 is also connected to the comparator 130, which controls the gain 27 for the automatic gain controller 26. A digital to analog converter (DAC) 108 and an interpolation filter 120 are located on the echo system output path 108. The signal output, which is the echo canceling signal, is then fed into the signal processor 12, through a secondary CECIA combined port 132. An extra delay element 134 is preferably located between the main input port 122 and the secondary CECIA input port 132.

This CECIA echo canceling system 100b and associated process 142 operate upon band-limited signals, in which introduced echoes 121, which may be produced during the process (due to imperfect cancellation), are comparatively smaller than the original echoes 34a-34n which are canceled. For convergence, the new introduced echoes 121 must be smaller than the original echoes 34a-34n, such that the magnitudes of the introduced echoes 121 are reduced after each iteration of the echo cancellation process 142, and eventually become negligible.

The desired signal R_{d}(n) ACF 54d is preferably used as the ACF reference 128 within the alternate echo cancellation structure 100b and associated process 142, to drive the output signal ACF R_{y}(n) 54y toward convergence.

Derivation of Tap Weight Updating Equations. As described above, the tap weights 104 within the echo cancellation structure 100 are each initially set to zero. During the iterative echo cancellation process 142, the tap weights 104 are subsequently updated, as shown:

w(n)←w(n)−e (n) (24)

$$e ( n ) = \frac{{R}_{y} ( n + {n}_{d} )}{{a}^{2} {K}^{3}} - α {R}_{d} ( n + {n}_{d} ) \qquad ( 25 )$$

where e(n) is the weight error vector, and (x is a proportionality constant. As described above, the output signal ACF R_{y}(n) 54y is scaled by 1/(a²K³), such that the convolution of the output signal ACF R_{y}(n) 54y with the output signal y(n) 18, as seen in Equation (23), is matched with the echoes 34 at the input port, as seen in Equation (20).

The desired reference output signal ACF R_{d}(n) 28 is scaled by the scaling factor α, which is determined, as described below, so that the error vector eventually becomes zero at the convergence of the CECIA process 142. As described above, the output signal ACF R_{y}(n) 54y and the desired signal ACF R_{d}(n) are adjusted for the delay through the DCSF 24.

As described above, for a system 12 having white echoes 34a-34n, the power may readily be determined, since the correlation peaks in the ACF tail 58 are distinct. However, for a band-limited signal having overlapping correlation peaks at the ACF tail 58, the input signal power a² can not be determined directly. Within the CECIA process 142, the input signal power a² is determined iteratively, using known information regarding the desired signal. The power of echo-free signal at the output is

R_{y}(0)=a²K²R_{d}(0) (26)

For a composite band-limited signal having one or more echoes 34a-34n, the power of the signal at the output is typically affected by the contribution of the echoes 34a-34n to the output signal power. However, for echoes 34a-34n which are assumed to be small, the power of echo-free signal at the output may be approximated by Equation (26), such that the power of the composite signal is estimated by

$${a}^{2} ≅ \frac{{R}_{y} ( 0 )}{{K}^{2} {R}_{d} ( 0 )} . \qquad ( 27 )$$

Substituting Equation (27) into Equation (25), the tap weight error vector e(n) is given as shown:

$$e ( n ) = \frac{{R}_{d} ( 0 )}{K {R}_{y} ( 0 )} {R}_{y} ( n + {n}_{d} ) - α {R}_{d} ( n + {n}_{d} ) . \qquad ( 28 )$$

The tap weight error vector e(n) must converge to zero as the output signal ACF R_{y}(n) approaches a²K²R_{d}(n), such that

$$0 = \frac{{R}_{d} ( 0 )}{K {R}_{y} ( 0 )} {R}_{y} ( 0 ) - α {R}_{d} ( 0 ) . \qquad ( 29 )$$

Therefore, the scaling factor α is given as

$$α = \frac{1}{K} \qquad ( 30 )$$

After each iteration within the CECIA process 142, the output signal s(n) 18 becomes increasingly free of echoes 34, which also results in a more accurate estimation of the input signal power, as given by Equation (27). The substitution of Equation (30) into Equation (28) yields the tap weight error vector e(n), as shown:

$$e ( n ) = \frac{1}{K} ( \frac{{R}_{d} ( 0 )}{{R}_{y} ( 0 )} {R}_{y} ( n + {n}_{d} ) - {R}_{d} ( n + {n}_{d} ) ) . \qquad ( 31 )$$

Equalization of the Output Signal Autocorrelation Function. For signal processing applications in which more the one CDMA band is selected, the input signal 16 may have non-uniform power levels across the selected bands. Therefore, the power spectrum of the signal, as provided by Equation (22), is not matched with the power spectrum of the echoes 34a-34n, since the estimated power spectrum is heavily weighted in the bands which have the highest power levels.

Thus, before the ACF tail 58 is used to generate the echo canceling signal 117 (FIG. 11), the ACF tail 58 is preferably equalized with the inverse filter of the output signal ACF Rₛ(n) 54y in the passband. As power levels in different CDMA bands are unknown and are always changing, the power levels are preferably estimated continuously, i.e. during each iteration, by the CECIA system 100b, from the output signal spectrum.

Due to the presence of echoes 34a-34n, the power level within a selected band may vary over a large interval. The average power levels are estimated, at step 160 (FIG. 13), in each selected band for equalization. As the echoes 34a-34n become smaller after each iteration of the CECIA process 142b, the quality of the output signal 18 is improved, and the average estimations converge to the true power levels of the selected bands.

ACF Equalizer Design. As power levels within selected CDMA bands change continuously for a wireless band-limited signal, the ACF equalizer 124 shown in FIG. 11 must be an adaptive system, but should not require a heavy computational cost associated with real-time filter synthesis.

Some preferred embodiments of the ACF equalizer 124 comprises one or more bandpass filters 125a-125k, having one bandpass filter 125 for each of the selected bands of the signal. Once the power in each band has been determined, the coefficients of each of the bandpass filters 125a-125k are weighted, to be inversely proportional to the square root of the power of the processed output signal 18. The weighted coefficients are then summed, to form the coefficients of the equalizer 127 (FIG. 11). The filter coefficients of the equalizer 124 are expressed as

$${b}_{e} ( n ) = \sqrt{{p}_{e}} {\sum }_{i} \frac{{b}_{i} ( n )}{\sqrt{{p}_{i}}} \qquad ( 32 )$$

where b₁(n) is the coefficient of the ith bandpass filter 25i, where p₁ is the estimated average power in the ith CDMA band, and where

$${p}_{e} = \frac{1}{N} {\sum }_{i} {p}_{i} \qquad ( 33 )$$

is the average power over all the selected bands. Since the CECIA process 142b provides normalization for the signal power, the use of pₑ in Equation (32) is not mandatory. However, the preferred use of pₑ in Equation (32) can reduce round-off error, if the estimated average power p, for each of the bands is very large.

In embodiments of the ACF equalizer 124 which comprise a plurality of bandpass filters 125a-125k, having one bandpass filter 125 for each of the selected bands, each of the bandpass filters 125 preferably has a flat response over its passband. As well, the ACF equalizer 124, which is a combined filter, preferably has smooth transitions over adjacent bands. In alternate embodiments of the ACF equalizer 124, the bandwidth of a filter 125, e.g. such as bandpass filter 125b, may be extended into adjacent bands, e.g. such as in relation to bandpass filters 125a, 125c, as seen in FIG. 11.

In some embodiments of the ACF equalizer 124, the FIR bandpass filters 125 are designed using MATLAB™ SIGNAL PROCESSING TOOLBOX™ software, from The Mathworks, Inc., of Natick, Mass. Various embodiments of bandpass filters 125 are provided for the following configurations:

No adjacent band. In this embodiment, the selected band 179 has no neighbor, and the transition band (TB) 181 can be as large as B/2, where B is the bandwidth of the passband, providing a flat response in the passband.

One adjacent band to the right. For this filter embodiment, the left transition band 181 can be as large as B/2, while the right transition band 181 is narrower than B/2, e.g. B/4, to yield a faster transition to the adjacent band 179.

One adjacent band to the left. In this embodiment, the right transition band 181 can be as large as B/2, while the left transition band 181 is narrower than B/2, e.g. B/4, to yield a faster transition to the adjacent band 179.

Two adjacent bands. In this embodiment, the selected band 179 has neighboring bands 179 on both sides, so both the right transition band 181 and the left transition band 181 are narrower than B/2, e.g. B/4.

The ACF equalizer 124 is not an inverse filter for the output signal ACF R_{y}(n) 54y, as the unselected bands 179 are not required to be equalized. Finite transition between adjacent selected bands 179 which have different power levels can result in the inaccurate weighting of the filter coefficients 125 in these bands. However, this inaccuracy is usually negligible, and does not affect the convergence of the CECIA process 142b.

As described above, the digital channel selecting filter DCSF 24 is initially assumed to be an ideal bandpass filter 24, in which the power spectrum of the echoes 34a-34n does not change when the echoes 34a-34n pass through the DCSF 24.

For a non-ideal digital channel selecting filter DCSF 24, as seen in Equation (21), the output signal ACF R_{y}(n) 54y is required to be equalized with the inverse filter of the desired signal ACF R_{d}(n) 54d, to generate a perfect echo canceling signal. However, a preferred channel selecting filter 24, such as a 255-tap FIR filter 24, provides small ripples in the passband, and strong attenuation in the stopband, which can eliminate the need to perform this equalization step. As well, any signal error which may be generated by less than perfect echo cancellation is typically small, and often becomes negligible after one or more iterations of the echo cancellation process 142.

Effects of Extra Signal Delay. Delay and dispersion which is typically introduced b y a digital channel selecting filter DCSF 24 can limit the range of tap weights 104a-104n within the echo canceling system 100, thereby degrading the performance of the echo canceller 100.

As seen from Equation (24) and Equation (31), the output signal ACF R_{y}(n) 54y is used for controllably setting the tap weights 104a-104n, within the range n_{d}≦n≦nₘₐₓ, where nₘₐₓ is the maximum time lag. While nₘₐₓ can be chosen to be sufficiently large, to cover the length of the channel, the delay n_{d} is fixed. Therefore, for 0≦n<n_{d}, a portion of the information associated with the channel contained in the output signal ACF R_{y}(n) 54y is not captured.

As seen in FIG. 6 through FIG. 9, the first echo 34 at the output is delayed by n₁+n_{d}, with respect to the DCSF impulse response h_{d}(n) 28. In this example, if n₁ is small, as compared to n_{d}, there is a large overlapping region which occurs between the correlation peak, due to this echo 34 and other correlation peaks 68a-68j, in the interval 0≦n<n_{d}. Therefore, newly introduced echoes 121 which are created in this interval, during weight adaptation, may be large, and may not inherently be removed.

The echo cancellation system 100b shown in FIG. 11 preferably comprises an additional delay nₑ 134 in the main signal path of the signal processor 12, which increases the delay of the echoes 34a-34n with respect to the DCSF impulse response h_{d}(n) 28, and reduces the overlapping of the correlation peaks 61 with the DCSF impulse response h_{d}(n) 28. The value of the preferred additional delay nₑ 134 is typically chosen such that nₑ+n₁≧n_{d}, or equivalently nₑ≧n_{d}−n₁. For signal processing applications in which n₁≧n_{d}, there is sufficient separation between the desired signal h_{d}(n) U5 28 and the IR peaks 56a-56i associated with echoes 34, so the extra delay nₑ 134 is not needed to improve the performance of the echo canceller 100b.

Determination of FIR Filter Length and Maximum Time Lag. Since the impulse response of the digital channel selecting filter DCSF 24 has a duration of 2n_{d}, the AC F tail 58, which represents the echoes 34a-34n, has a length of 2n_{d}+nₛ. The length of the FIR filter 102 is also preferably at least 2n_{d}+nₛ, to cancel the echoes effectively. The echo delay spread nₛ 39 can be estimated from the antenna separation, propagation conditions, and separation of time diversity signals used in the repeater 102. Typically, the echo delay spread nₛ 39 is between 100 and 150, so for a digital channel selecting filter DCSF 24 having 255 taps, the length of the FIR filter 104 can be chosen to be 400.

In applications in which only primary echoes 34 are assumed to be significant, the magnitude of the output signal ACF R_{y}(n) 54y is substantially zero beyond the maximum time lag nₘₐₓ=nₑ+n₁+2n_{d}+nₛ. Therefore, the output signal ACF R_{y}(n) 54y is only required to be determined for n≦nₘₐₓ only. As well, the cancellation of primary echoes 34 also cancels secondary echoes 34 which are present in the composite signal. Therefore, it is typically not necessary to compute the output signal ACF R_{y}(n) 54y beyond the maximum time lag nₘₐₓ, even if the magnitude of the output signal ACF R_{y}(n) 54y beyond nₘₐₓ is not negligible.

Estimation of Delay in Echo Canceling Signal Path. The combined delay of the echo canceling signal 117 (FIG. 11), through the DAC 118, the interpolation filter IPF 120, and the ADC 25 is typically small. However, if this combined delay is not accurately known, the performance of the echo canceller 100b may be adversely affected.

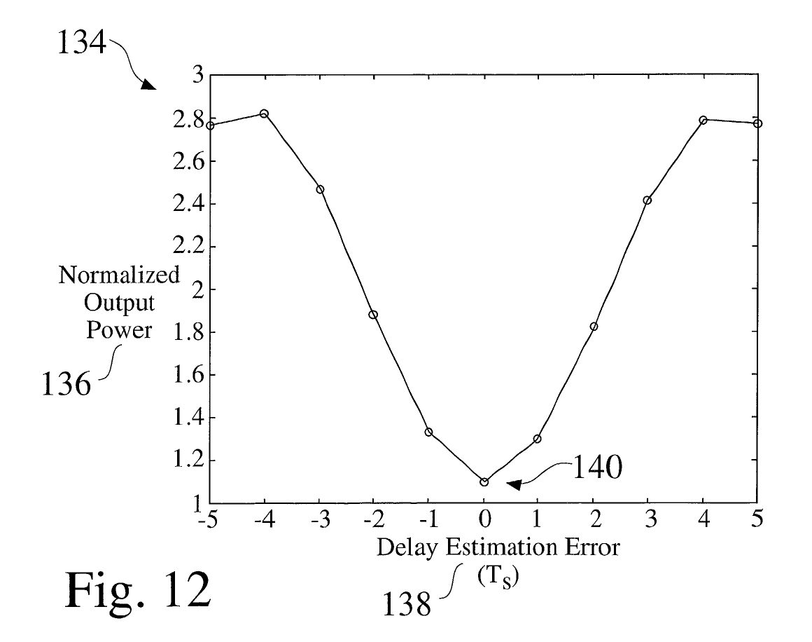

For example, if a canceling signal 117 is slightly out of phase with the echoes 34a-34n, the canceling signal 117 may not cancel the echoes 34a-34n, and may even introduce new echoes 121, which can cause system instability. Under normal operation, when the system is thermally stable, it is expected that this delay does not change, or may vary within a small interval of a fraction of the sampling period. Assuming this delay variation is slow, compared to the adapting rate of the echo canceller 100b, the combined delay can be estimated, by shifting the tap weights 104a-104n of the FIR filter 102, for different values in the known delay interval, while measuring the output signal power 136 (FIG. 12). The true delay is then determined to be the value of the shifted tap weights 104a-104n which yields the lowest output power 140, resulting from the most effective echo cancellation.

In signal processing applications in which the combined delay through the echo cancellation path devices 118, 120, 25 may not be a multiple of the sampling periods, the combined delay may preferably be estimated 152 (FIG. 13) using data interpolation. The tap weights 104a-104n of the FIR filter 102 are then calculated 164 from this delay estimation, and the output signal ACF R_{y}(n) 54y is then estimated, through interpolation.

FIG. 12 is a graph 134 which shows normalized output power 136, as a function of delay estimation error 138, after a first iteration of an echo cancellation process 100b, where the power is normalized against that of the desired echo-free signal ACF h_{d}(n) 28, i.e. the reference ACF 28. When the delay estimation error 138 is zero, the power 136 is lowest 140, since most of echoes 34a-34n have been canceled in the first iteration. If the combined delay is not a multiple of sampling periods, the location of power minimum 140 is found by interpolation. Given three successive points with coordinates (n₂−1, pₜ), (n₂, p₂) and (n₂+1, p₂), where p₂ is the lowest power value, the location of the minimum 140, using second-order curve fitting, is given by:

$$x = \frac{( {n}_{2} + 0.5 ) {p}_{1} - 2 {n}_{2} {p}_{2} + ( {n}_{2} - 0.5 ) {p}_{3}}{{p}_{1} - 2 {p}_{2} + {p}_{3}} \qquad ( 34 )$$

If a=x−nₐ, where nₐ≦x≦nₐ+1, the new autocorrelation function ACF which is used for setting tap weights 104a-104n of the echo canceller FIR filter 102 is preferably determined using the linear interpolation

R_{y}′(n)=(1−a)R_{y}(n)+aR_{y}(n+1). (35)

Thus, for an arbitrary, non-zero delay in the echo canceling signal path 104, 106, the error weight vector given in Equation (31) is replaced by

$$e ( n ) = \frac{1}{K} ( \frac{{R}_{d} ( 0 )}{{R}_{y}^{′} ( 0 )} {R}_{y}^{′} ( n + {n}_{d} + {n}_{a} ) - {R}_{d} ( n + {n}_{d} + {n}_{a} ) ) , \qquad ( 36 )$$

where R_{y}′(n)=(1−a)R_{y}(n)+aR_{y}(n+1), as given by Equation (35), and (nₐ+a) is the estimated combined delay through the DAC 118, the IPF 120, and the ADC 25.

In general, ACF equalization 162 (FIG. 13) is also needed, such as performed by the ACF equalizer 124, which means

R_{y}′(n)={(1−a)R_{y}(n)+aR_{y}(n+1)}*bₑ(n) (37)

where bₑ(n) is the filter coefficients 125a-125k of the ACF equalizer 124, as given in Equation (32).

Convolutional Echo Cancellation Process. FIG. 13 is a simplified block diagram of the CECIA process 142b for canceling band-limited echoes 34a-34n which are present in a band-limited signal, for the echo cancellation system 100b shown in FIG. 11 and the ACF equalizer 124, as described above, in which the process 142b comprises the steps of

calculating the reference autocorrelation function ACF R_{d}(n) of an ideal, echo-free signal, at step 146;

setting the gain K 27 of the automatic gain controller AGC 116 to a small value, at step 148, such that echoes 34a-34n are reduced to such a level that makes the system stable;

initializing the tap weights 104a-104n of the FIR filter 102, at step 150, such that w(n)=0 for all values of n;

determining the combined signal delay through the DAC 118, IPF 120 and ADC 29, at step 152;

sampling the output signal of the signal processor 12, at step 154;

calculating the autocorrelation function ACF R_{y}(n) of the sampled output signal, at step 156;

calculating the power spectrum of the output signal, e.g. Φ_{y}(k)=FFT(R_{y}(n)), at step 158, e.g. such as by a FFT module 126;

calculating the average power levels in the selected bands, at step 160;

equalizing the ACF R_{y}(n), at step 162, using the ACF equalizer 124 and the calculated power levels;

updating the tap weights 104a-104n, at step 164, such that w(n) w(n)−e(n), where the weight error vector e(n) is given by Equation (36);

increasing the gain of the automatic gain controller AGC 116, at step 166, such that K 2K to a maximum value 170 of K=1; and

if the increased gain K<1, as seen at step 168, reiterating the process by returning to the output signal sampling step 154. When the increased gain K reaches a maximum value of K=1, at 170, the process may be stopped 176.

For continuous iterative echo tracking and cancellation, at step 172, when the increased gain K reaches a maximum value of K=1, at 170, the CECIA process 142 returns to the signal delay determination step 152.

In contrast to the white echo cancellation system 100a, where the echoes are canceled gradually, starting with the echoes 34 having largest delays and moving back in time to echoes 34 having smaller delays, the CECIA system 100b process 142 for band-limited cancellation attempts to cancel all the echoes 34a-34n at once, during each iteration of the process, and then iterates the process, to cancel any echoes 34a-34n which remain, and/or to cancel any newly created echoes 121 which may result from the previous imperfect cancellation.

In alternate embodiments of the echo cancellation system 100b, echoes 34a-34n which occur at different delays 49 are processed and gradually canceled, such as for white echo cancellation. However, the use of gradual cancellation for a band-limited signal does not typically improve echo cancellation performance significantly, and may be computationally expensive. Such an alternate echo cancellation process 100 can be implemented successfully, and converges, as long as the gain K 27 of the AGC 26 is small enough to keep the echoes 34a-34n small, thereby providing a stable system.

Examples of CECIA Echo Cancellation. FIG. 14 is a graph 177 showing a plurality of neighboring CDMA bands 179. In an exemplary embodiment of the echo cancellation system 100b, described below, the repeater 12 has a digital channel selecting filter DCSF 24 that can select any of 11 CDMA bands 179, in which each band 179 is 1.25 MHz wide, having center frequencies ranging from 3.25 MHz to 15.75 MHz.

The sampling frequency for the sampling step 154 is fₛ=50 Mhz, which is 40 times the band-width of a CDMA band 179, and the sampling period is Tₛ=1/fₛ=20 ns. The DCSF 24 is symmetric 255-tap FIR filter 102 with a group delay of 127Tₛ. A typical impulse response 73 of the DCSF is shown in FIG. 7, where the third CDMA band has been selected. In general, when more than one CDMA band 179 is selected, the impulse response of the FIR filter 102 is less dispersive.

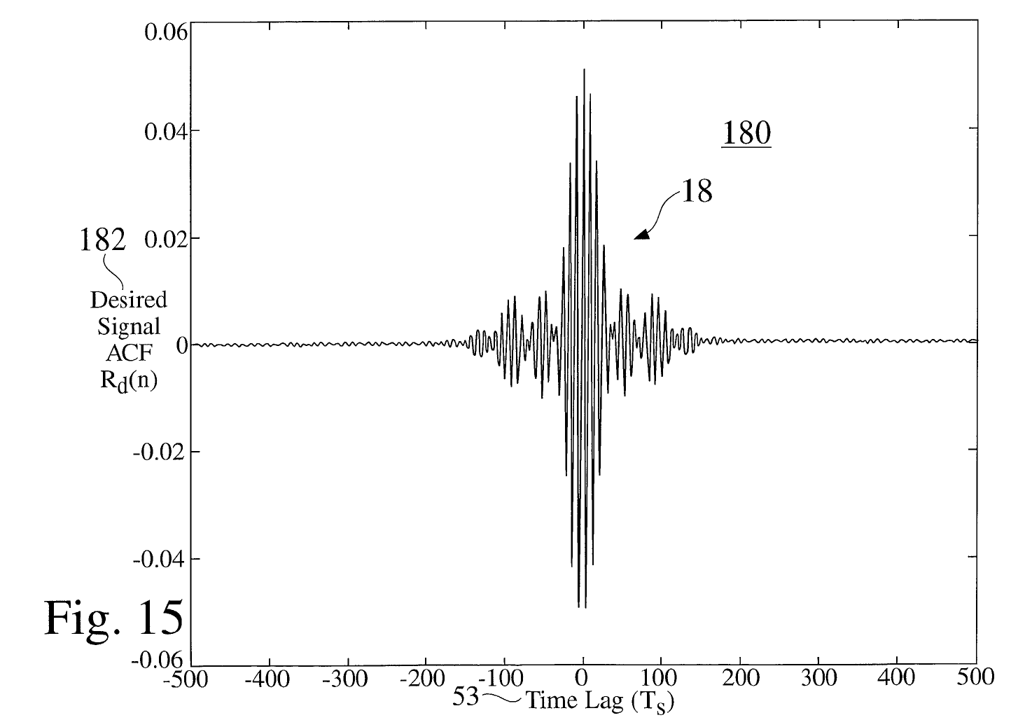

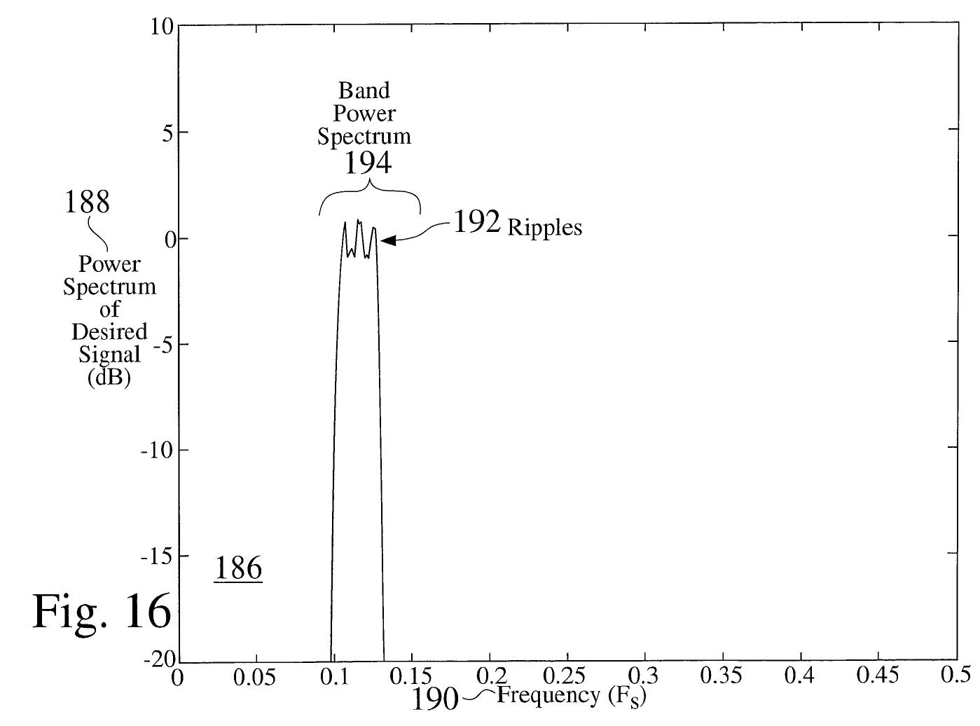

FIG. 15 is a graph 180 which shows the autocorrelation function 182 of an echo-free signal 18 which has a uniform power spectrum 194 (FIG. 16) across a selected band. FIG. 16 is a graph 186 which shows the power spectrum 188 for the echo-free signal 18 of FIG. 15. In this example, only the third CDMA band is selected. As seen in FIG. 16, the band power spectrum 194 has ripples 192 of an approximate magnitude of 0.75 dB in the passband, which is a result of the design of the digital channel selecting filter DCSF 24. The stopband of the designed DCSF 24 is 40 dB below the pass-band, but in the computed power spectrum, the stopband is less than 30 dB, which is a result of the use of a finite number of samples in this estimation, and does not reflect the true signal-to-noise ratio of the desired output signal 18.

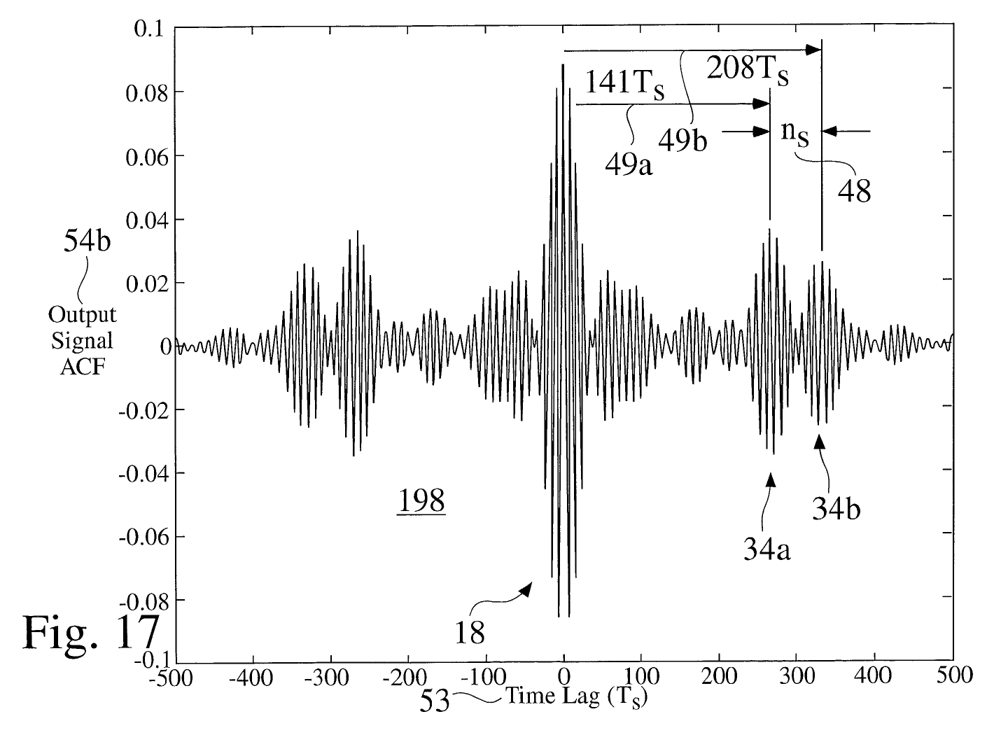

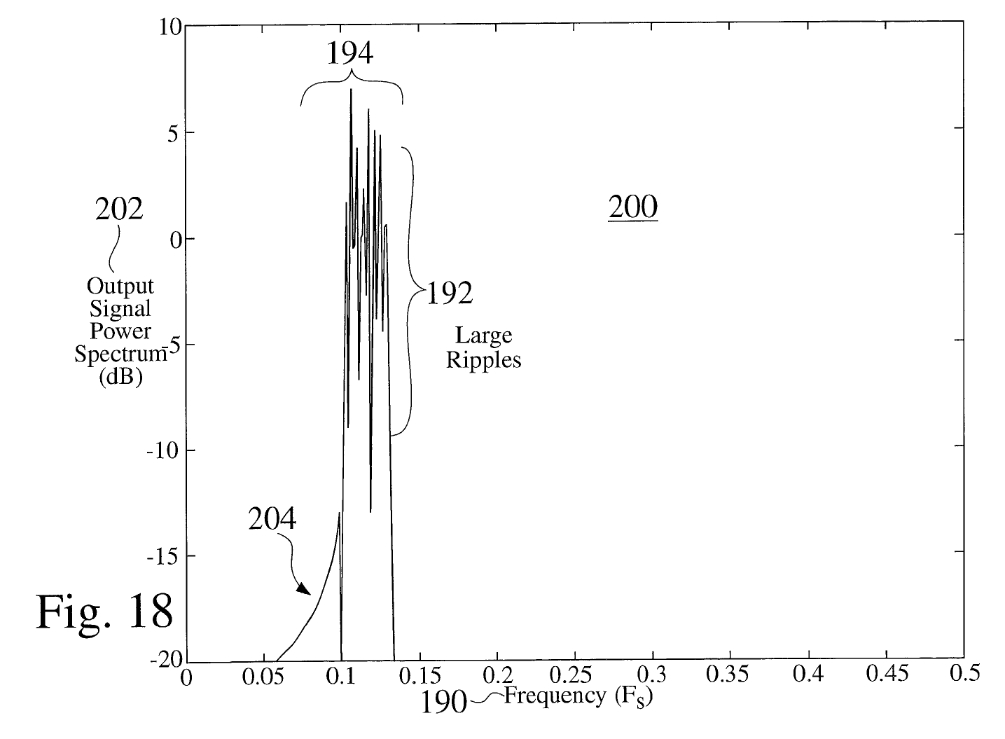

FIG. 17 is a graph 198 which shows the output signal ACF R_{y}(n) 54y for the signal of FIG. 13, in the presence of two echoes 34a, 34b, having respective delays 49a, 49b of 141Tₛ and 208Tₛ, and respective magnitudes of 7 and 5 relative to the output signal 18. As seen in FIG. 17, the output signal ACF R_{y}(n) 54y is extended significantly, as compared to the output signal ACF R_{y}(n) 54y of the echo-free output signal 18 shown in FIG. 15. FIG. 18 is a graph 200 which shows the power spectrum 194 for the output signal 18 of FIG. 17, in the presence of two echoes 34a, 34b. As seen in FIG. 18, the output signal power spectrum 194 has large ripples 192, due to the presences of echoes 34a, 34b. For a gain of K=0.1, the system is stable, so the CECIA process 142 may be applied to efficiently cancel the echoes 34a, 34b, such that the processed output signal 18 readily converges. Since the delay 49a of the first echo 34a is larger than the group delay of the digital channel selecting filter DCSF 24, there is no requirement for adding an extra delay 144. As seen in FIG. 17, the echo delay spread nₛ 48 is relatively small, so that a 373-tap FIR filter 104 is sufficient for echo cancellation. In this example, since there is only one CDMA band selected, an AC F equalization step 162 is not required. In this example, except for the delay through the DCSF 24, the delay of the echo canceling signal through the echo cancellation system devices, i.e. the DAC 118, the interpolation filter 120, and the ADC 29, is assumed to be negligible.

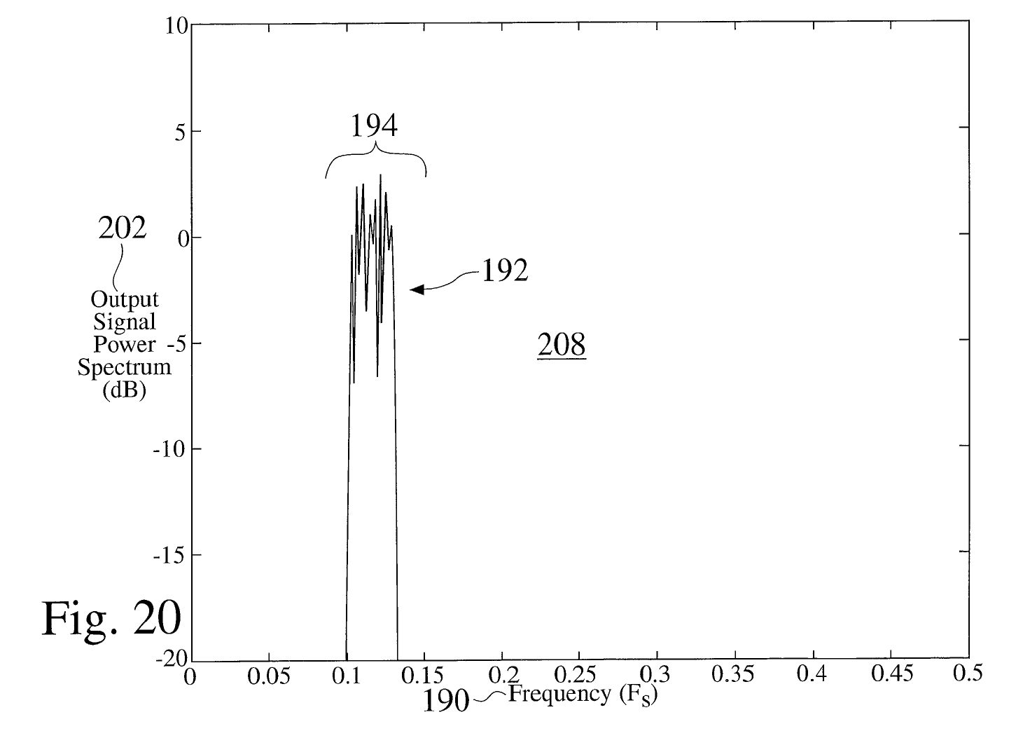

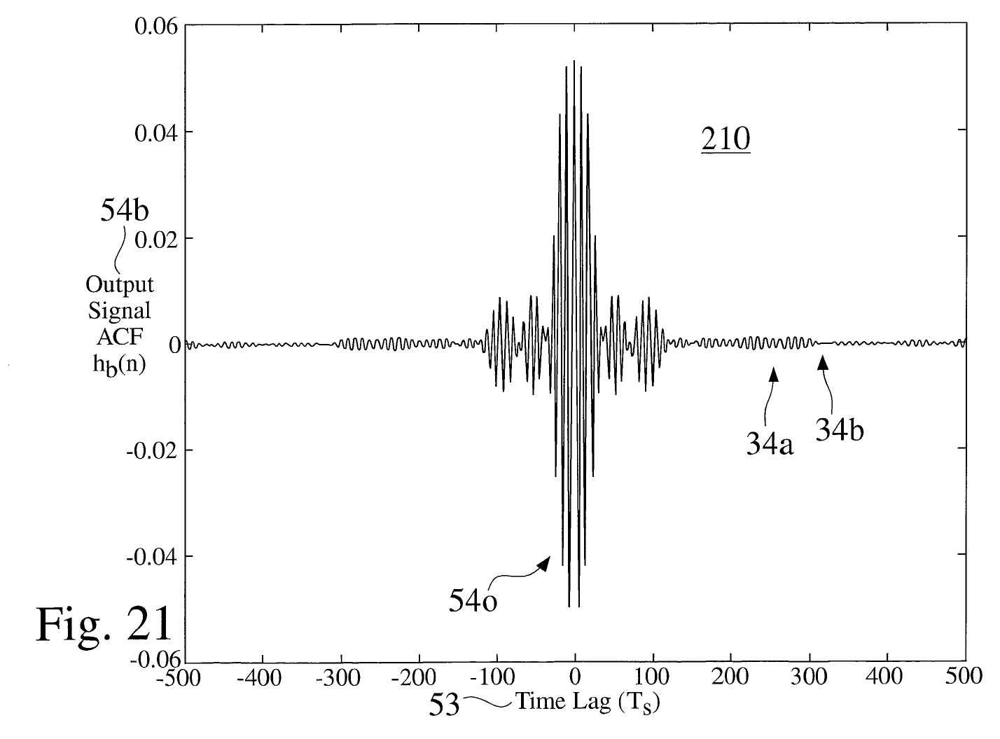

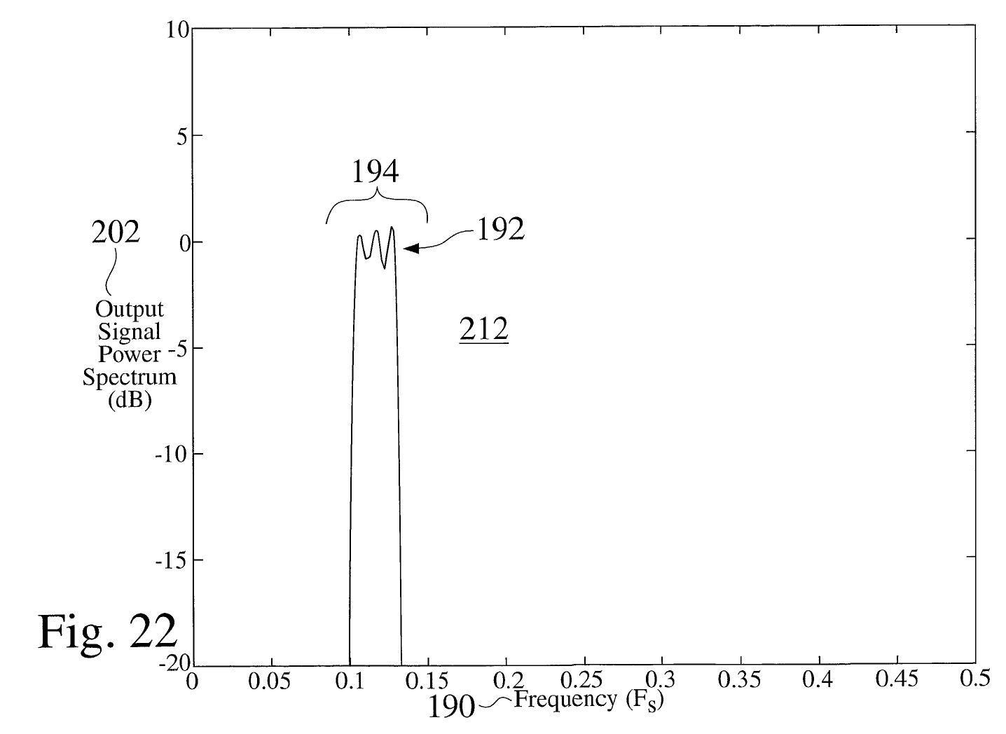

FIG. 19 is a graph 206 showing the composite signal ACF 54y for the output signal 18 shown in FIG. 17, after a first iteration of the echo cancellation process 162. FIG. 20 is a graph 208 showing the power spectrum 202 for the output signal 18 shown in FIG. 17, after a first iteration of the echo cancellation process 142. The echo canceling process 142 converges quickly, as seen in FIG. 21, which is a graph 210 showing the composite signal ACF 54y for the output signal 18 shown in FIG. 17, after a fourth iteration of the echo cancellation process 142. FIG. 22 is a graph 212 showing the power spectrum 202 for the output signal 18 shown in FIG. 17, after a fourth iteration of the echo cancellation process 142, where the ripple magnitude 192 in the passband is reduced to 0.75 dB. The ripple power after adaptation is calculated as the difference between the powers of the output and echo-free output signals 18. Compared to the original echo power, the reduction is 57.8 dB.

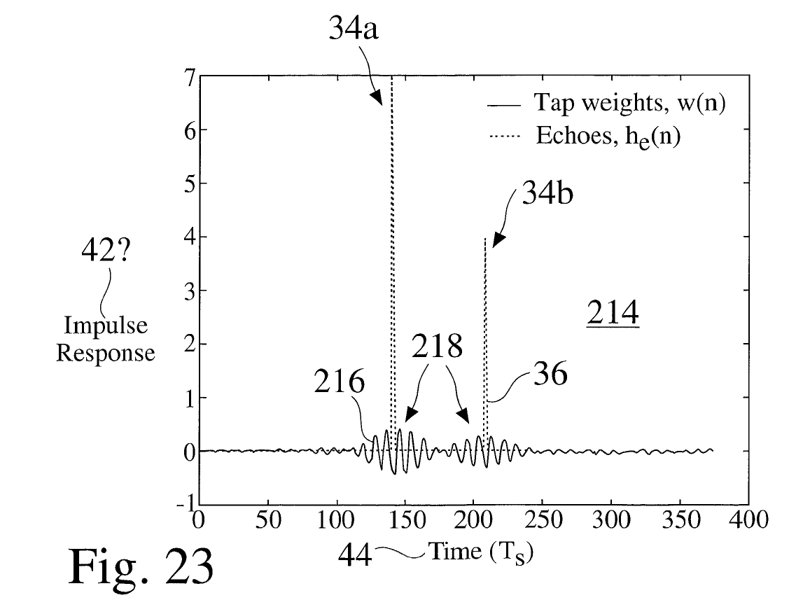

FIG. 23 is a graph 214 which shows the final FIR filter tap weight impulse response 216, along with the delayed echo channel impulse response hₑ(n) 36 for the output signal 18 shown in FIG. 17, after a fourth iteration of the echo cancellation process 142. As seen in FIG. 23, the echoes 34a and 34b are well separated in this example, such that the local extrema 218 of the tap weights 104 coincide with the locations of the echoes 34a, 34b, and the magnitudes of the tap weights are proportional to those of the echoes 34a, 34b, which indicates that echo cancellation is taking place. In this example, the delay spread is relatively small, so only those tap weights 104 around the echoes 34 are significant, and the values of other tap weights 104 are very small. Therefore, for the output signal 18 shown in FIG. 17, sufficient echo cancellation is achieved with a small number of tap weights 104a-104n.

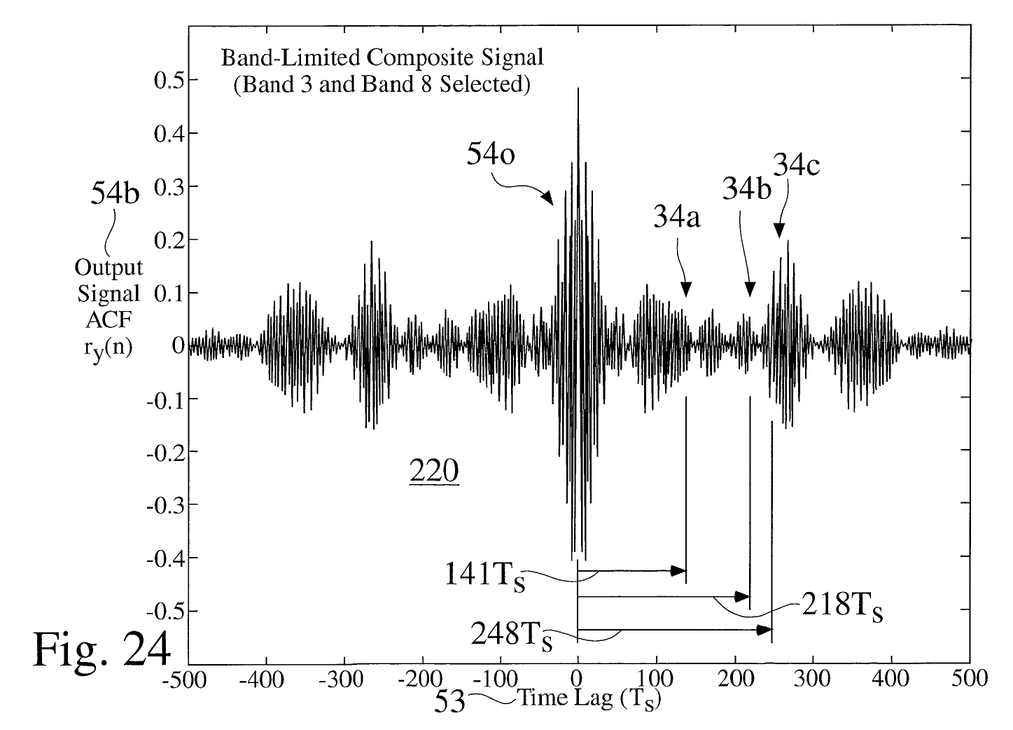

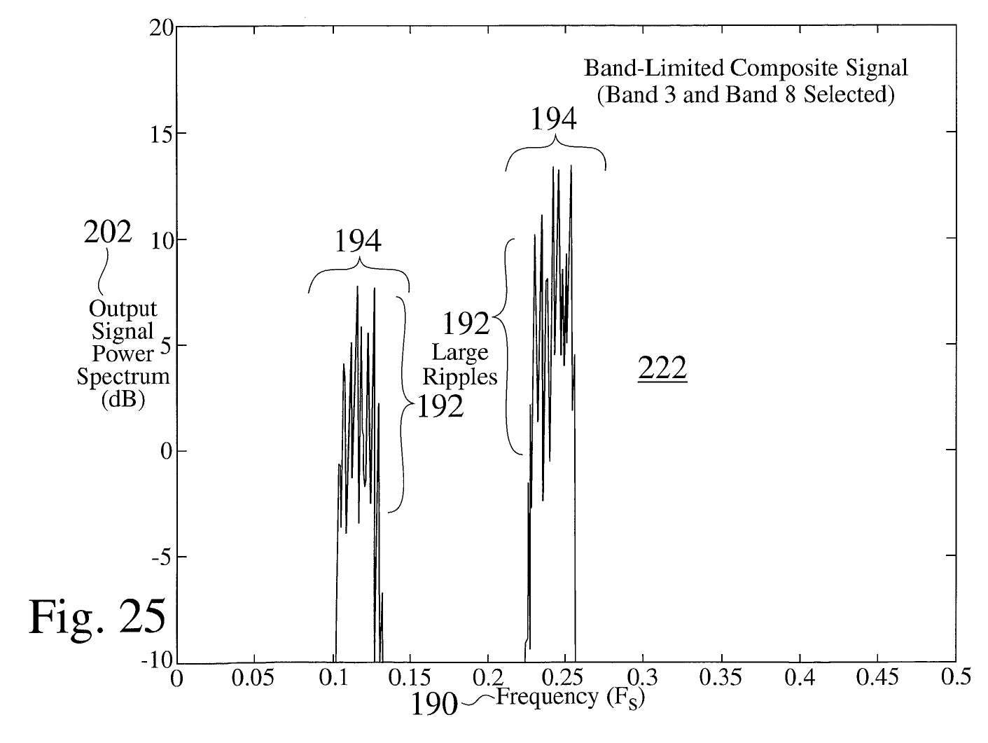

FIG. 24 is a graph 220 which shows the output signal ACF R_{y}(n) 54b, comprising the output signal ACF R_{y}(n) 54y for the signal of FIG. 13, in the presence of three echoes 34a, 34b, and 34c, with both the third and the eighth CDMA band selected. The three echoes 34a, 34b, and 34c have respective delays 49a, 49b, 49c of 141Tₛ, 218Tₛ and 248Tₛ, and respective magnitudes of 7, −4, and 5 relative to the desired echo-free output signal 18. FIG. 25 is a graph 222 which shows the output signal power spectrum 54b for the output signal 18 of FIG. 24. The power in the eighth band is approximately 6 dB above power in the third band, and the power spectrum 194 of both the third band and the eighth band have large ripples 192. As seen in FIG. 24, the output signal ACF R_{y}(n) 54y is extended significantly, as compared to the output signal ACF R_{y}(n) 54y of the echo-free output signal 18 shown in FIG. 15.

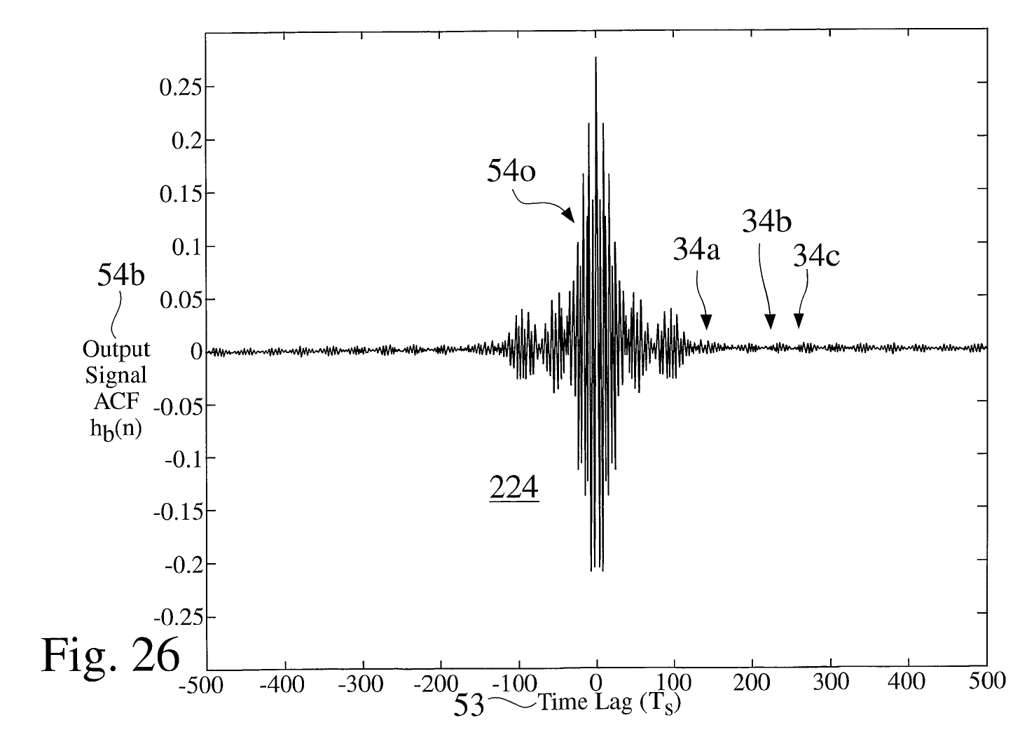

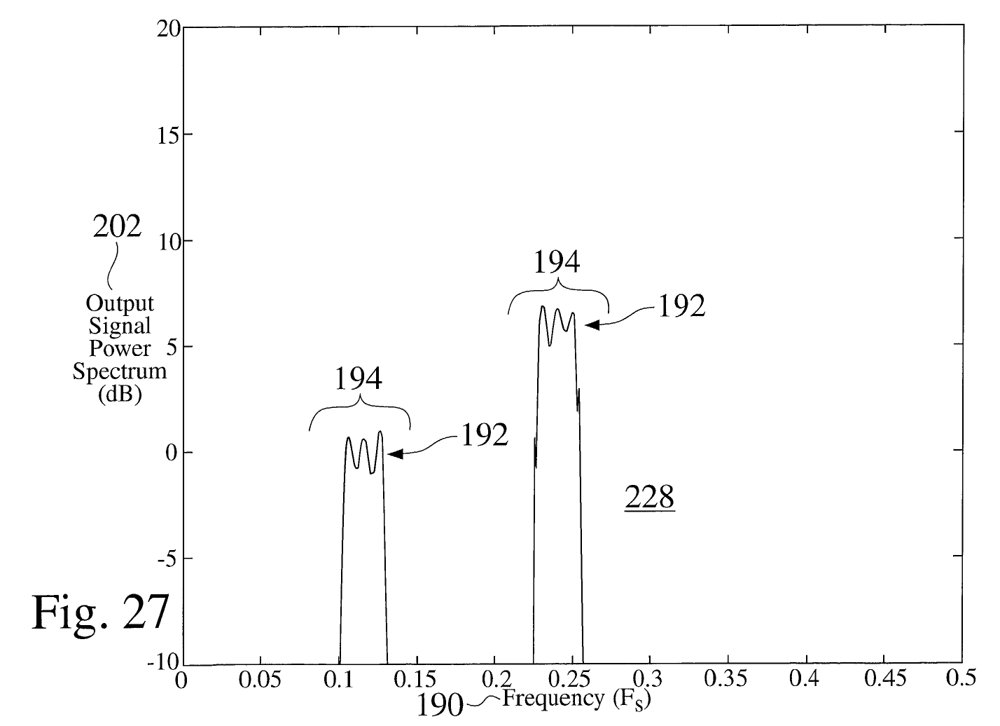

FIG. 26 is a graph 224 which shows the output signal ACF R_{y}(n) 54b for the output signal 18 of FIG. 24 after a fourth iteration of the echo cancellation process 142, for an echo canceller 100b having a FIR filter 102 comprising 373 taps 104a-104n. FIG. 27 is a graph 228 which shows the power spectrum 202 for the output signal 18 of FIG. 26, after a fourth iteration of the echo cancellation process 142, for an echo canceller 100b having a FIR filter 102 comprising 373 taps 104a-104n.

As seen in FIG. 27, the power levels 194 of the selected bands converge to approximately 0 dB and 6 dB respectively. In FIG. 27, the magnitude of the ripple 192 for each band is approximately 0.9 dB, which is slightly higher than the example shown in FIG. 22, Which is due to the larger delay spread and the higher echo power of the output signal 18 of FIG. 24 and FIG. 25. However, after only two additional iterations, the ripple magnitude 194 is reduced to the original level of 0.75 dB.

Correlation Noise and Thermal Noise Analysis of Echo Cancellation Process. The performance of the CECIA echo cancellation process 142 is primarily dependent upon the accuracy of the determined output signal ACF R_{y}(n) 54y. As discussed above, the accuracy of the determined output signal ACF R_{y}(n) 54y is dependent on the level of thermal noise which is present in the output signal 18, as well as the level of correlation noise, which is directly related to the number of samples used in the determination of the output signal ACF R_{y}(n) 54y.

The performance of the echo cancellation system 100b also depends on the echo power level, which means the stronger the echoes 34a-34n are, the higher the echo reduction is. Other meaningful measures of process performance include the signal to echo power ratio (SER), and the magnitude of ripples 194 in the output signal power spectrum 202, after echo cancellation. Without echoes 34a-34b, the output signal 18 is given by

y(n)=y_{d}(n)+yₜ(n) (38)

where

y_{d}(n)=Ks(n)*h_{d}(n) (39)

is the desired output signal 18, and yₜ(n) is thermal noise. Since y_{d}(n) and yₜ(n) are independent, the accuracy of the determined output signal ACF R_{y}(n) 54y is given by

R_{y}(n)=R_{yd}(n)+R_{yt}(n) (40)

where

R_{yd}(n)=K²Rₛ(n)*R_{d}(n) (41)

is the desired signal ACF R_{d}(n) 54d, and R_{yt}(n) is the thermal noise ACF. When estimated using an infinite number of samples, Rₛ(n) is given by Equation (9).

The ACF of an ergodic signal is estimated as

$${R}_{s} ( k ) = \frac{1}{N} {\sum }_{n = 1}^{N} s ( n ) s ( n + k ) , \qquad ( 42 )$$

where is “k” the time lag and “N” is the number of samples used in the estimation. In this estimation, R_{s,k} and sₙ denote the random variables (RVs) of Rₛ(k) and s(n), respectively. If s(n) is a white Gaussian signal, sₙ are identical, independent Gaussian RVs. If sₙ are assumed to have zero means and variance a², R_{s,0} has a chi-square distribution with N degrees of freedom and the mean is shown as

$$E \{ {R}_{s , 0} \} = \frac{1}{N} ( N {a}^{2} ) = {a}^{2} , \qquad ( 43 )$$

where E{} denotes an expectation operation. For non-zero time lag, R_{s,k} is Gaussian, using the Central Limit Theorem, as described by S. Haykin, An Introduction to Analog and Digital Communications, New York: John Wiley and Sons, 1989.

R_{s,k} is the sum of a large number of RV products with the mean

$$E \{ {R}_{s , k} \} = E \{ \frac{1}{N} {\sum }_{n = 1}^{N} {s}_{n} {s}_{n + K} \} = \frac{1}{N} {\sum }_{N = 1}^{N} E \{ {s}_{n} \} E \{ {s}_{n + k} \} = 0 , \qquad ( 44 )$$

where sₙ and sₙ₊ₖ are independent. The variance of is given by

$$E \{ {R}_{s , k}^{2} \} = E \{ {( \frac{1}{N} {\sum }_{n = 1}^{N} {s}_{n} {s}_{n + K} )}^{2} \} = \frac{1}{{N}^{2}} {\sum }_{N = 1}^{N} E \{ ( {s}_{n}^{2} {s}_{n + k}^{2} ) \} = \frac{{a}^{4}}{N} , \qquad ( 45 )$$

where the expectations of all cross-products are zeros. Combining Equation (42) through Equation (45), the autocorrelation function ACF of a white Gaussian signal is written as

$${R}_{s} ( k ) ≅ {a}^{2} δ ( k ) + g ( k ) \sqrt{\frac{{a}^{4}}{N}} = {a}^{2} ( δ ( k ) + \frac{g ( k )}{\sqrt{N}} ) \qquad ( 46 )$$

where g(k) is a Gaussian random variable RV with zero mean and unit variance. Therefore, for a finite number of samples N,

$${R}_{s} ( n ) = {a}^{2} \{ δ ( n ) + \frac{g ( n )}{\sqrt{N}} \} , \qquad ( 47 )$$

where g(n) is a white, Gaussian random process, with zero mean and unit variance. Similarly, if thermal noise is white and Gaussian, with rms amplitude aₜ, the thermal noise autocorrelation function ACF is given by

$${R}_{y t} ( n ) = {a}_{t}^{2} \{ δ ( n ) + \frac{g ( n )}{\sqrt{N}} \} ≅ {a}_{t}^{2} δ ( n ) , \qquad ( 48 )$$

where the second term in the sum is omitted, because the contribution of the second term in the sum to thermal noise is typically secondary, and is preferably assumed to b e negligible. The combination of Equation (40), Equation (41), Equation (47) and Equation (48) yields

$${R}_{y} ( n ) = {a}^{2} {K}^{2} {R}_{d} ( n ) + \frac{{a}^{2} {K}^{2}}{\sqrt{N}} {R}_{d} ( n ) * g ( n ) + {a}_{t}^{2} δ ( n ) . \qquad ( 49 )$$

The first term of the sum in Equation (49) is the desired signal ACF 54d, while the second and last terms correspond to correlation and thermal noise, respectively. For convenience, each of the terms in Equation (49) are denoted as R₁(n), R₂(n), and R₃(n), with the following ACFs:

$$\begin{matrix}{R}_{r1} ( n ) = {a}^{4} {K}^{4} {R}_{d} ( n ) * {R}_{d} ( - n ) = {a}^{4} {K}^{4} {R}_{d} ( n ) ; & ( 50 ) \\ {R}_{r2} ( n ) = \frac{{a}^{4} {K}^{4}}{N} {R}_{d} ( n ) * {R}_{d} ( - n ) * g ( n ) * g ( - n ) = \frac{{a}^{4} {K}^{4}}{N} {R}_{d} ( n ) ; and & ( 51 )\end{matrix}$$

Rᵣ₃(n)=aₜ⁴δ(n), (52)

where R_{d}(n)*R_{d}(−n)=R_{d}(n) for an ideal bandpass filter, and g(n)*g(−n)=δ(n). With the assumption that R_{y}(n) always converges toward a²K²R_{d}(n), the power ratio of the desired signal and residual echoes caused by the correlation noise is

$${Γ}_{c} = \frac{{R}_{r1} ( 0 )}{{R}_{r2} ( 0 )} = N , \qquad ( 53 )$$

and the power ratio of the desired signal and residue which is caused by thermal noise is

$${Γ}_{t} = \frac{{R}_{r1} ( 0 )}{{R}_{r3} ( 0 )} = \frac{{a}^{4} {K}^{4} {R}_{d} ( 0 )}{{a}_{i}^{4}} . \qquad ( 54 )$$

As seen in Equation 53, Γ_{c} is directly proportional to the number N of samples used in the computation of the output ACF, so that for 10,000 samples, the residual echoes due to correlation noise are 40 dB below the desired signal. If the echo power is 20 dB above the desired signal before cancellation, the echo reduction is 60 dB.

As seen in Equation 54, Γₜ is proportional to (a²/aₜ². For thermal noise which is 40 dB below the desired signal, the residual echoes 34 due to thermal noise is 80 dB below the desired signal. The power ratio of desired signal and total residual echoes is

$$Γ = \frac{{R}_{r1} ( 0 )}{{R}_{r2} ( 0 ) + {R}_{r3} ( 0 )} . \qquad ( 55 )$$

Therefore, unless thermal noise has a very high power, the effect of thermal noise on echo cancellation is insignificant.

Echo Cancellation System Computational Requirements. A large portion of the computational cost of the echo cancellation 100 and associated processes 142 are typically associated with the accurate determination of the output signal ACF R_{y}(n) 54y.

An effective method to compute the output signal ACF R_{y}(n) 54y comprises the steps of:

determining the fast Fourier transform (FFT) of the output signal 18 (thereby transforming from the time domain to the frequency domain);

determining the squared absolute value of the FFT to get the power spectrum of the output signal 18; and

taking the inverse FFT of the determined power spectrum (returning from the frequency domain back to the time domain).

Fast Fourier Transforms are described in A. V. Oppenheim and R. W. Schafer, Digital Signal Processing, Englewood Cliffs, N.J.: Prentice-Hall, 1975.

Since an FFT operation of N samples takes Nlog₂N multiplications, the number of multiplications for an ACF computation is 2Nlog,N+N. Typically, 10⁴ to 10⁵ samples are needed, depending how many CDMA bands are selected.

For an echo cancellation process 142 which takes an average of five iterations to converge, the numbers of multiplications needed are 1.38×10⁶ and 17.1×10⁶, respectively. In this example, for an echo cancellation system 100 comprising a digital signal processor which can perform over 1 GMAC per second, the ACF computation can be performed 58 to 725 times per second, respectively.

If the combined echo cancellation structure delay over the DAC 118, IPF 129, and ADC 29 is estimated for every adaptation cycle, the computational cost may be twice as large. However, for most output signals, continuous tracking and canceling takes less than five iterations to converge. Therefore, a 1 GMAC DSP processor can perform over 100 adaptations per second.

The FIR filter 102 within the echo canceller structure 100, which operates in real time, is typically more computationally intensive than the algorithm itself.

System Advantages. The echo cancellation processes 142a, 142b are based upon the second-order statistics of the received output signal 18, and do not require a training signal. Unlike other blind techniques, which either require cyclostationarity or higher-order statistics of the received signal, the CECIA process 142b can be applied to cancel the echoes 34a-34b of Gaussian, noise-like signals with no special signal structure.

For signal processing systems in which echoes 34a-34b are white, the echo cancellation process 142a can extract the channel impulse response, and cancel the echoes 34a-34n, using iterative autocorrelation. For signal processing systems in which echoes 34a-34b are band-limited, in which the channel impulse response cannot be determined, the echoes 34a-34b can be canceled directly, using the convolutional echo cancellation process 142b.

The echo cancellation structures 100 and associated processes 142 can achieve echo cancellation of more than 40 dB at modest computational cost of several hundred MMACs. Most of this cost is associated with the determination of the second-order statistics of the signal, such as the autocorrelation function or the power spectrum of the sampled signal. The echo cancellation structures 100 and associated processes 142 can cancel a virtually infinite number of echoes 34a-34n in any channel, as long as the echo delay spread is finite. In one example, when the delay spread is long, an echo canceller comprising a 400-tap FIR filter 102, operating at 50 MHz sampling rate, can cancel echoes 34a-34n in a channel, with a delay spread as long as 3 μs. The echo cancellation structures 100 and associated processes 142 can update the weights of the FIR filter 102 every millisecond or less. This is highly desirable for many wireless applications, where the propagation conditions change fast and often require an adaptation rate of 50 times per second or more.

Although the echo canceling system and its methods of use are described herein in connection with CDMA repeaters and other wireless signal processors, the apparatus and techniques can be implemented within other communications devices and systems, or any combination thereof, as desired.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

What is claimed is:

1. A process for canceling echoes for a band-limited signal within a signal processor having a signal input and a signal output, comprising the steps of:
providing an echo system processing circuit between said signal processor output and said signal processor input, comprising a FIR filter, said FIR filter having at least one controllable tap weight. calculating a reference autocorrelation function ACF R_{d}(n) of a reference signal;
adjustably controlling gain K through said signal processor to reduce said at least one echo;
initializing said at least one tap weight;
determining the combined signal delay through said echo system processing circuit;
sampling said band-limited signal at said signal processor output;
calculating the autocorrelation function ACF R_{y}(n) of said sampled output signal;
calculating the power spectrum of said sampled output signal, said power spectrum comprising one or more selected bands;
calculating the average power levels of said selected bands in said calculated power spectrum;
equalizing said autocorrelation function ACF R_{y}(n) of said sampled output signal, at step 162, using said calculated power levels of said selected bands;
updating said at least one tap weight, based upon said equalized autocorrelation function ACF R_{y}(n) of said sampled output signal;
incrementally increasing gain K through said signal processor, to a maximum value of K=1; and
if said incrementally increased gain K<1, returning to said signal sampling step.

2. The process of claim 1, further comprising:
if said incrementally increased gain K=1, returning to said signal delay determination step.

3. A process for creating an echo cancellation signal for a composite band-limited signal within a signal processor having a signal input and a signal output, said band-limited signal comprising a desired band-limited signal and at least one echo, said process comprising the steps of:
determining second order statistics of said composite band-limited signal;
calculating a portion of said second order statistics of said composite band-limited signal which is related to said at least one echo;
determining a negative value of said portion;
time adjusting said negative value of said portion;
scaling said time adjusted negative value of said portion; and
processing said composite band-limited signal with said time adjusted negative value of said portion.

4. The process of claim 3, wherein the signal processor further comprises a digital channel selecting filter.

5. The process of claim 4, wherein said digital channel selecting filter is an allpass filter.

6. The process of claim 3, wherein said scaling step comprises scaling said time adjusted negative value of said portion by 1/(a2K3), where “a” is the rms amplitude of said composite band-limited signal, and where “K” is the variable gain of said processor.

7. A system for a signal processor for a band-limited signal comprising a desired band-limited signal and at least one echo, said system comprising an input, a gain, and an output, comprising:
a filter connected between said output and said input of said signal processor, said filter comprising at least one controllable tap weight;
an autocorrelation module attached to said output of said signal processor, said autocorrelation module providing signal analysis of a received signal at said output of said signal processor;
an ACF equalizer connected to said autocorrelation module, said ACF equalizer comprising at least one bandpass filter;
a FFT module connected to said autocorrelation module, said FFT module for determining second order statistics of said received analyzed signal;
a gain calculator connected between said ACF equalizer, said FFT module, and said gain of said signal processor, said gain calculator for controlling gain of signal processor, based upon output of said ACF equalizer and said FFT module; and
a tap weight calculator connected between said ACF equalizer, said FFT module, and said filter, said tap weight calculator for controlling each of said at least one controllable tap weight, based upon said output of said ACF equalizer and said FFT module.

8. The system of claim 7, further comprising:
a DAC connected between said filter and said input of said signal processor.

9. The system of claim 7, further comprising:
an interpolation filter connected between said filter and said input of said signal processor.

10. The system of claim 7, wherein said filter is a FIR filter.

11. The system of claim 10, wherein said FIR filter is an alipass filter.

12. The system of claim 7, wherein said determined second order statistics of said received analyzed signal comprises a calculated power spectrum of said received analyzed signal.

13. The system of claim 7, further comprising:
an ACF reference signal input connected to said weight calculator and said gain calculator,
the system of claim 13, wherein said ACF reference signal input comprises said desired band-limited signal.
